(19) United States
(12) Patent Application Publication
(10) Pub. No.: US 2022/0211040 A1
(43) Pub. Date: Jul. 7, 2022

(54) HIGH SPREADING ULV FORMULATIONS FOR INSECTICIDES

(71) Applicant: Bayer Aktiengesellschaft, Leverkusen (DE)

(72) Inventors: Gorka PERIS URQUIJO, Köln (DE); Oliver GAERTZEN, Köln (DE); Holger EGGER, Köln (DE); Malcolm FAERS, Düsseldorf (DE); Emilia HILZ, Haan (DE); Silvia CEREZO-GALVEZ, Langenfeld (DE)

(73) Assignee: Bayer Aktiengesellschaft, Leverkusen (DE)

(21) Appl. No.: 17/595,082

(22) PCT Filed: May 8, 2020
(86) PCT No.: PCT/EP2020/062906

§ 371 Date: Nov. 8, 2021

(30) Foreign Application Priority Data
May 8, 2019 (EP) 19173402.9
May 8, 2019 (EP) 19173403.7
May 8, 2019 (EP) 19173404.5

(51) Int. Cl. A01N 43/56; A01N 25/30; A01N 25/06

(52) U.S. Cl. CPC A01N 43/56; A01N 25/06; A01N 25/30

(57) ABSTRACT

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

The present invention relates to agrochemical compositions: their use for foliar application; their use at low spray volumes; their use by unmanned aerial systems (UAS), unmanned guided vehicles (UGV), and tractor mounted boom sprayers fitted with conventional nozzles but also pulse width modulation spray nozzles or rotating disc droplet applicators; and their application for controlling agricultural pests, weeds or diseases, in particular on waxy leaves.

Modern agriculture faces many challenges in producing sufficient food in a safe and sustainable way. There is therefore a need to utilise crop protection products to enhance the safety, quality and yield while minimising the impact to the environment and agricultural land. Many crop protection products, whether chemical or biological, are normally applied at relatively high spray volumes, for example in selected cases>50 L/ha, and often>150-400 L/ha. A consequence of this is that much energy must be expended to carry the high volume of spray liquid and then apply it to the crop by spray application. This can be performed by large tractors which on account of their weight and also the weight of the spray liquid produce CO₂ from the mechanical work involved and also cause detrimental compaction of the soil, affecting root growth, health and yield of the plants, as well as the energy subsequently expended in remediating these effects.

There is a need for a solution that significantly reduces the high volumes of spray liquid and reduces the weight of the equipment required to apply the product.

In agriculture, low spray volume application technologies including unmanned aerial systems (UAS), unmanned guided vehicles (UGV), and tractor mounted boom sprayers fitted with pulse width modulation spray nozzles or rotating disc droplet applicators are offering farmers solutions to apply products with low spray volumes, typically down to 10 to 20 1/ha or less. These solutions have advantages including for example that they require significantly less water which is important in regions where the supply of water is limited, require less energy to transport and apply the spray liquid, are faster both from quicker filling of the spray tank and faster application, reduce the CO₂ generation from both the reduced volume of spray liquid to transport and from the use of smaller and lighter vehicles, reduced soil compaction damage, and enabling the use of cheaper application systems.

However, Wang et al [Field evaluation of an unmanned aerial vehicle (UAV) sprayer: effect of spray volume on deposition and the control of pests and disease in wheat. Pest Management Science 2019 doi/epdf/10.1002/ps.5321] demonstrated that as the spray volume is decreased from 450 and 225 1/ha to 28.1, 16.8 and 9.0 1/ha, the coverage (% area), number of spray deposits per area, and diameter of the spray deposits as measured on water sensitive paper all decreased (see Table 3 in Wang et al, 2019). In parallel, the biological control efficacy for both wheat aphid control and powdery mildew control decreased at low spray volumes with the greatest decrease observed at 9.0 1/ha, followed by 16.8 1/ha (see FIGS. 6, 7 and 8 in Wang et al, 2019).

There is therefore a need to design formulation systems that overcome the reduction in the coverage and diameter of the spray deposits at low spray volumes even through the number of spray deposits per area is decreasing: as the spray volume decreases, the number of spray droplets per unit area decreases proportionately for the same spray droplet spectra size. This is especially necessary below 25 1/ha, more especially below 17 1/ha, and even more especially at 10 1/ha and below.

The solution is provided by formulations containing a surprising low total amount applied per ha of organosilicone surfactant, below the level normally used and below the level where the organosilicone surfactant is expected to work. Such formulations give increased coverage and increased diameter of spray deposits at low spray volumes. Furthermore, the increased coverage and increased diameter of spray deposits is comparable to the coverage obtained at normal higher spray volumes. Furthermore, the formulations exemplifying the invention are particularly effective on hard to wet leaf surfaces where more conventional spray volumes have poor retention and coverage.

A particular advantage of the invention stemming from the low total amount of organosilicone-based surfactant compared to the level required at normal higher spray volumes is lower cost of formulations and their ease of production. Further advantages include improved formulation stability and simplified manufacture, less cost of goods as well as less impact on the environment.

The use of organosilicone-based surfactants as tank mix adjuvants has existed for many years, with the recognition that lower spray volumes can be advantageous. R. Gaskin et al [Adjuvant prescriptions to lower water volumes and improve disease control in vineyards, ISAA 2004 proceedings; R. Gaskin et al, New adjuvant technology for pesticide use on wine grapes, New Zealand Plant Protection 55:154-158 (2002); and R. Gaskin et al, Use of a superspreader adjuvant to reduce spray application volumes on avocados, New Zealand Avocado Growers' Association Annual Research Report 2004. 4:8-12]report that organosilicone-based surfactants can be advantageous to reduce spray volumes. However, these refer to relatively high spray volumes, from 100 to 2500 1/ha, and high adjuvant doses, 100 to 800 gl/ha. They do not show or suggest that organosilicone-based surfactants could offer advantages at very low spray volumes, typically down to 10-20 1/ha, or even below, and also at low doses of surfactant, typically 50 g/h and below.

R. Gaskin et al [Effect of surfactant concentration and spray volume on retention of organosilicone sprays on wheat, Proc. 50th N.Z. Plant Protection Conf 1997: 139-142] concluded that organosilicone-based surfactants are expected to enhance the retention of pesticide sprays on difficult-to-wet arable species over a wide range of spray application volumes. However, the data only covered 37 to 280 1/ha and only referred to retention pesticide sprays but not to plant coverage or size of the spray deposits. Furthermore, there was no mention of ultra-low spray volumes according to the present invention with application volumes down to 10-20 1/ha and in particular embodiments even below this, e.g. down to 1-5 1/ha.

All of these refer to tank-mix adjuvants and not to ready to use formulations.

The formulations of the invention, which are most preferably ready to use formulations in contrast to tank mixes, offer the advantage of low spray volumes and thus, low but still effective amounts of active ingredients on the plants by using a higher concentration of organosilicone in the formulations of the invention as indicated herein resulting due to the low spray volume in a lower abundance in the environment after application.

Formulations, also for tank mixes, known in the prior art containing organosilicone-based surfactants are principally designed for much higher spray volumes and generally contain lower concentrations of organosilicone-based surfactants in the spray broth. Nevertheless, due to the high spray volumes used in the prior art, the total amount of organosilicone surfactant used and therefore in the environment is higher than according to the present invention.

The concentration of the organosilicone surfactant is an important element of the invention, since suitable spreading occurs when a certain minimum concentration of organosilicone surfactant is achieved, normally 0.05% w/w or w/v (these are equivalent since the density of the organosilicone surfactant is approximately 1.0 g/cm³).

For clarifications sake, as it is understood by a skilled person, spreading means the immediate spreading of a droplet on a surface, i.e. in the context of the present invention the surface of the part of a plant such as a leaf.

Therefore, in a spray volume of 500 1/ha as it is used in the prior art, about 250 g/ha of organosilicone surfactant would be required to achieve suitable spreading. Hence, faced with the task to reduce the spray volume, the skilled person would apply the same concentration of organosilicone surfactant in the formulation. For example for a spray volume of 10 1/ha about 5 g/ha (about 0.05% in the spray broth) surfactant would be required. However, at such a low volume with such low concentration of organosilicon surfactant sufficient spreading cannot be achieved (see examples).

In this invention, we have surprisingly found that increasing the concentration of organosilicone surfactant as the spray volume decreases can compensate for the loss in coverage (due to insufficient spreading) from the reduction in spray volume. It was surprisingly found that for every reduction of the spray volume by 50%, the concentration of surfactant should roughly be doubled.

Thus, although the absolute concentration of the organosilicone-surfactant is increased compared to formulations known in the art, the relative total amount per ha can be decreased, which is advantageous, both economically and ecologically, while coverage by and efficacy of the formulation according to the invention is improved, maintained or at least kept at an acceptable level when other benefits of the low volume applications are considered, e.g. less costs of formulation due to less cost of goods, smaller vehicles with less working costs, less compacting of soil etc.

A further part of the invention that allows surprising low total amount of organosilicone-based surfactants to be used is the surface texture of the target crop leaves. Bico et al [Wetting of textured surfaces, Colloids and Surfaces A, 206 (2002) 41-46] have established that compared to smooth surfaces, textured surfaces can enhance the wetting for formulation spray dilutions with a contact angles<90° and reduce the wetting for contact angles>90°.

This is also the case for leaf surfaces, in particular textured leaf surfaces, when sprayed in a method according to the invention resulting in low total amounts (per ha) of organosilicone-based surfactants due to the low spray volumes with formulations according to the invention having a high concentration of the organosilicone surfactant. Remarkably high coverage of the leaf surfaces by the spray liquid, even to a level greater than would be normally be expected, could be demonstrated.

Textured leaf surfaces include leaves containing micron-scale wax crystals on the surface such as wheat, barley, rice, rapeseed, soybean (young plants) and cabbage for example, and leaves with surface textures such as lotus plant leaves for example. The surface texture can be determined by scanning electron microscope (SEM) observations and the leaf wettability determined by measuring the contact angle made by a drop of water on the leaf surface.

In summary, the object of the present invention is to provide a formulation which can be applied in ultra-low volumes, i.e. <20 1/ha, while still providing good leaf coverage, uptake and biological efficacy against insects and at the same time reducing the amounts of additional additives applied per ha, as well as a method of using said formulation at ultra-low volumes (<20 1/ha), and the use of said formulation for application in ultra-low volumes as defined above.

While the application on textured leaves is preferred, surprisingly it was found that also on non-textured leaves the formulations according to the instant invention showed good spreading and coverage as well as other properties compared to classical spray application formulations for 200 1/ha.

In one aspect, the present invention is directed to the use of the compositions according to the invention for foliar application.

If not otherwise indicated, % in this application means percent by weight (% w/w).

It is understood that in case of combinations of various components, the percentages of all components of the formulations always sum up to 100.

Further, if not otherwise indicated, the reference “to volume” for carriers indicates that the carrier is added to 1000 ml (11) or to 1000 g (1 kg)

Further, it is understood, that the preferred given ranges of the application volumes or application rates as well as of the respective ingredients as given in the instant specification can be freely combined and all combinations are disclosed herein, however, in a more preferred embodiment, the ingredients are preferably present in the ranges of the same degree of preference, and even more preferred the ingredients are present in the most preferred ranges.

In one aspect, the invention refers to a formulation comprising:
a) One or more active ingredients selected from the group of agrochemically applied insecticides,
b) At least one organosilicone based surfactant (preferably a polyalkyleneoxide modified heptamethyltrisiloxane),
c) one or more other formulants, and
d) one or more carriers to volume (1 L or 1 kg),
wherein b) is present in 0.5 to 15% by weight.

If not otherwise indicated in the present invention the carrier is usually used to volume the formulation. Preferably, the concentration of carrier in the formulation according to the invention is at least 5% w/w, more preferred at least 10% w/w such as at least 20% w/w, at least 40% w/w, at least 50% w/w, at least 60% w/w, at least 70% w/w and at least 80% w/w.

The formulation is preferably a spray application to be used on crops.

In a preferred embodiment the formulation of the instant invention comprises
a) One or more active ingredients selected from the group of agrochemically applied insecticides,
b) At least one organosilicone based surfactant (preferably a polyalkyleneoxide modified heptamethyltrisiloxane), and
c1) At least one suitable non-ionic surfactant and/or suitable ionic surfactant.
c2) Optionally, a rheological modifier
c3) Optionally, a suitable antifoam substance
c4) Optionally, suitable other formulants
d) carriers solid or liquid.
In another embodiment at least one of c2, c3 and c4 are mandatory, preferably, at least two of c2, c3 and c4 are mandatory, and in yet another embodiment c2, c3 and c4 are mandatory.
In a preferred embodiment component, a) is preferably present in an amount from 0.5 to 30% by weight, preferably from 1 to 27.5% by weight, and most preferred from 1.2 to 25% by weight.
In an alternative embodiment a) is present from 1 to 5% by weight.
In another embodiment a) is present from 5 to 12% by weight.
In yet another embodiment a) is present from 10 to 20% by weight.
In a preferred embodiment component b) is present in 0.5 to 15% by weight, preferably from 0.75 to 10% by weight, and more preferred from 1.0 to 6% by weight.
In a preferred embodiment the one or more component c) are present in 0.5 to 65% by weight, preferably from 1 to 49.5% by weight, and more preferred from 2 to 37.5% by weight.
In a preferred embodiment the one or more component c1) is present in 0.5 to 20% by weight, preferably in 1 to 17.5% by weight and most preferred in 2 to 15% by weight.
In a preferred embodiment the one or more component c2) is present in 0 to 20% by weight, preferably in 0 to 15% by weight and most preferred in 0 to 10% by weight.
In a preferred embodiment the one or more component c3) is present in 0 to 5% by weight, preferably in 0 to 2% by weight and most preferred in 0 to 0.5% by weight.
In a preferred embodiment the one or more component c4) is present in 0 to 20% by weight, preferably in 0 to 15% by weight and most preferred in 0 to 12% by weight.

In case c2 is mandatory, it is present in 0.1 to 20% by weight.

In case c3 is mandatory, it is present in 0.05 to 5% by weight.

In case c4 is mandatory, it is present in 0.1 to 20% by weight.

In one embodiment the formulation comprises the components a) to d) in the following amounts
a) 0.5 to 30% by weight
b) 0.5 to 15% by weight
c1) 0.5 to 20% by weight
c2) 0 to 20% by weight
c3) 0 to 5% by weight
c4) 0 to 20% by weight
d) carrier to volume.

In another embodiment the formulation comprises the components a) to d) in the following amounts
a) 1 to 27.5% by weight
b) 0.75 to 10% by weight
c1) 1 to 17.5% by weight
c2) 0 to 15% by weight
c3) 0 to 2% by weight
c4) 0 to 15% by weight
d) carrier to volume.

In one embodiment the formulation comprises the components a) to c) in the following amounts
a) 1.2 to 25% by weight
b) 1 to 6% by weight
c1) 2 to 15% by weight
c2) 0 to 10% by weight
c3) 0 to 0.5% by weight
c4) 0 to 12% by weight
d) carrier to volume.

In yet another embodiment the formulation comprises the components a) to c) in the following amounts
a) 1.2 to 25% by weight
b) 1 to 6% by weight
c1) 2 to 15% by weight
c2) 0.1 to 20% by weight
c3) 0.05 to 5% by weight
c4) 0.1 to 20% by weight
d) carrier to volume.

As indicated above, component d) is always added to volume, i.e. to 11, or to 1 kg, so that the weight % add up to 100.

In a further preferred embodiment of the present invention the formulation consists only of the above described ingredients a) to d) in the specified amounts and ranges.
The instant invention further applies to a method of application of the above referenced formulations, wherein the formulation is applied at a spray volume of between 1 and 20 1/ha, preferably 2 and 15 1/ha, more preferably 5 and 15 1/ha.
More preferred, the instant invention applies to a method of application of the above referenced formulations, wherein the formulation is applied at a spray volume of between 1 and 20 1/ha, preferably 2 and 15 1/ha, more preferably 5 and 15 1/ha,
and the amount of b) is present in 0.5 to 15% by weight, preferably from 0.75 to 10% by weight, and more preferred from 1 to 6% by weight,
wherein in a further preferred embodiment a) is present in an amount from 0.5 to 30% by weight, preferably from 1 to 27.5% by weight, and most preferred from 1.2 to 25% by weight.
In an alternative embodiment a) is present from 1 to 5% by weight.
In another embodiment a) is present from 5 to 12% by weight.
In yet another embodiment a) is present from 15 to 25% by weight.
In another aspect the instant invention applies to a method of application of the above referenced formulations,
wherein the formulation is applied at a spray volume of between 1 and 20 1/ha, preferably 2 and 15 1/ha, more preferably 5 and 15 1/ha, and
wherein preferably the applied amount of a) to the crop is between 2 and 250 g/ha, preferably between 5 and 225 g/ha, and more preferred between 10 and 200 g/ha.
In one embodiment, the with the above indicated method applied amount of a) to the crop is between 2 and 10 g/ha.
In another embodiment, the with the above indicated method applied amount of a) to the crop is between 40 and 110 g/ha.
In one embodiment in the applications described above, the active ingredient (ai) a) is preferably applied under field conditions from 2 and 250 g/ha, preferably between 5 and 225 g/ha, and more preferred between 10 and 200 g/ha, while correspondingly the organosilicone-surfactant b) is preferably applied from 5 g/ha to 150 g/ha, more preferably from 7.5 g/ha to 100 g/ha, and most preferred from 10 g/ha to 60 g/ha.

In particular the formulations of the instant invention are useful for application on plants or crops with textured leaf surfaces.

The corresponding doses of organosilicone surfactant (b) in formulations according to the invention to the applied doses are:

A 2 1/ha liquid formulation delivering
50 g/ha of organosilicone surfactant contains 25 g/l of surfactant (b).
30 g/ha of organosilicone surfactant contains 15 g/l of surfactant (b).
12 g/ha of organosilicone surfactant contains 6 g/l of surfactant (b).
10 g/ha of organosilicone surfactant contains 5 g/l of surfactant (b).

A 11/ha liquid formulation delivering:
50 g/ha of organosilicone surfactant contains 50 g/l of surfactant (b),
30 g/ha of organosilicone surfactant contains 30 g/l of surfactant (b),
12 g/ha of organosilicone surfactant contains 12 g/l of surfactant (b),
10 g/ha of organosilicone surfactant contains 10 g/l of surfactant (b).

A 0.5 1/ha liquid formulation delivering:
50 g/ha of organosilicone surfactant contains 100 g/l of surfactant (b),
30 g/ha of organosilicone surfactant contains 60 g/l of surfactant (b),
12 g/ha of organosilicone surfactant contains 24 g/l of surfactant (b),
10 g/ha of organosilicone surfactant contains 20 g/l of surfactant (b).

A 0.2 1/ha liquid formulation delivering:
50 g/ha of organosilicone surfactant contains 250 g/l of surfactant (b),
30 g/ha of organosilicone surfactant contains 150 g/l of surfactant (b),
12 g/ha of organosilicone surfactant contains 60 g/l of surfactant (b),
10 g/ha of organosilicone surfactant contains 50 g/l of surfactant (b).

A 2 kg/ha solid formulation delivering:
50 g/ha of organosilicone surfactant contains 25 g/kg of surfactant (b),
30 g/ha of organosilicone surfactant contains 15 g/kg of surfactant (b),
12 g/ha of organosilicone surfactant contains 6 g/kg of surfactant (b),
10 g/ha of organosilicone surfactant contains 5 g/kg of surfactant (b).

A 1 kg/ha solid formulation delivering:
50 g/ha of organosilicone surfactant contains 50 g/kg of surfactant (b),
30 g/ha of organosilicone surfactant contains 30 g/kg of surfactant (b),
12 g/ha of organosilicone surfactant contains 12 g/kg of surfactant (b),
10 g/ha of organosilicone surfactant contains 10 g/kg of surfactant (b).

A 0.5 kg/ha solid formulation delivering:
50 g/ha of organosilicone surfactant contains 100 g/kg of surfactant (b),
30 g/ha of organosilicone surfactant contains 60 g/kg of surfactant (b),
12 g/ha of organosilicone surfactant contains 24 g/kg of surfactant (b),
10 g/ha of organosilicone surfactant contains 20 g/kg of surfactant (b).

The concentrations of organosilicone surfactant (b) in formulations that are applied at other dose per hectare rates can be calculated in the same way.

In the context of the present invention, suitable formulation types are by definition suspension concentrates, aqueous suspensions, suspo-emulsions or capsule suspensions, emulsion concentrates, water dispersible granules, oil dispersions, emulsifiable concentrates, dispersible concentrates, preferably suspension concentrates, aqueous suspensions, suspo-emulsions, oil dispersions, emulsifiable concentrates, and water dispersable granules wherein in the case of non-aqueous formulations or solid formulations the sprayable formulations are obtained by adding water.

Therefore, in one embodiment the formulation is obtained by dilution to volume with a carrier from a suspension concentrate (SC).

The SC according to the instant invention comprises
a) 0.025-30% active ingredient, preferably 0.5-15%.
b) 0.025-15% organo silicone surfactant, preferably 0.05-7.5%
c) 12.5%-90%, preferably 25%-45%
wherein the c1 to c4 are present in
c1) 0.025-20%, preferably, 0.5-10%
c2) 0.005-20%, preferably, 0.01-10%
c3) 0.0025-5%, preferably, 0.005-2.5%
c4) 0.005-20%, preferably, 0.01-10%

In one embodiment the formulation is obtained by dilution to volume with a carrier from a wettable granule (WG).

The WG according to the instant invention comprises
a) 0.025-30% active ingredient, preferably 0.5-15%.
b) 0.025-15% organo silicone surfactant, preferably 0.05-7.5%
c) 12.5%-90%, preferably 25%-45%
wherein the c1 to c4 are present in
c1) 0.025-20%, preferably, 0.5-10%
c2) 0-20%, preferably, 0-10%
c3) 0.0025-5%, preferably, 0.005-2.5%
c4) 0.005-20%, preferably, 0.01-10%

In one embodiment the formulation is obtained by dilution to volume with a carrier from an emulsion concentrate (EC).

The EC according to the instant invention comprises
a) 0.025-30% active ingredient, preferably 0.5-15%.
b) 0.025-15% organo silicone surfactant, preferably 0.05-7.5%
c) 12.5%-90%, preferably 25%-45%
wherein the c1 to c4 are present in
c1) 0.025-20%, preferably, 0.5-10%
c2) 0-20%, preferably, 0-10%
c3) 0.0025-5%, preferably, 0.005-2.5%
c4) 0.005-20%, preferably, 0.01-10%

In one embodiment the formulation is obtained by dilution to volume with a carrier from an oil dispersion (OD).

The OD according to the instant invention comprises
a) 0.025-30% active ingredient, preferably 0.5-15%.
b) 0.025-15% organo silicone surfactant, preferably 0.05-7.5%
c1) 0.025-20%, preferably, 0.5-10%
c2) 0.005-20%, preferably, 0.01-10%
c3) 0.0025-5%, preferably, 0.005-2.5%
c4) 0.005-20%, preferably, 0.01-10%

Active Ingredients (a):

Agronomically used insecticides, acaricides and/or nematicides as meant in this invention, here mentioned with their, “common name”, are known and described e.g. in, “The Pesticide Manual” 16th Ed., British Crop Protection Council 2012, or can be found in internet (e.g. http://www.alanwood.net/pesticides). Their classification is based on the IRAC Mode of Action Classification Scheme as known at filing date.

(1) Acetylcholinesterase(AChE)-inhibitors, e.g. Carbamates Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC andan Xylylcarb, or organophosphates, e.g. Acephat, Azamethiphos, Azinphos-ethyl, Azinphos-methyl, Cadusafos, Chlorethoxyfos, Chlorfenvinphos, Chlormephos, Chlorpyrifos-methyl, Coumaphos, Cyanophos, Demeton-S-methyl, Diazinon, Dichlorvos/DDVP, Dicrotophos, Dimethoat, Dimethylvinphos, Disulfoton, EPN, Ethion, Ethoprophos, Famphur, Fenamiphos, Fenitrothion, Fenthion, Fosthiazat, Heptenophos, Imicyafos, Isofenphos, Isopropyl-O-(methoxyaminothio-phosphoryl)salicylat, Isoxathion, Malathion, Mecarbam, Methamidophos, Methidathion, Mevinphos, Monocrotophos, Naled, Omethoate, Oxydemeton-methyl, Parathion-methyl, Phenthoat, Phorat, Phosalon, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Triclorfon andand Vamidothion.

(2) GABA-gated chloride channel antagonists, preferably Cyclodien-organochlorine selected from the group of Chlordan and Endosulfan, or Phenylpyrazole (Fiprole) selected from Ethiprol and Fipronil.

(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Momfluorothrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin and Transfluthrin or DDT or Methoxychlor.

(4) Nicotinic acetylcholine receptor (nAChR) competitive activators, preferably Neonicotinoids selected from Acetamiprid, Clothianidin, Dinotefuran, Imidacloprid, Nitenpyram, Thiacloprid and Thiamethoxam, or Nicotin, or Sulfoximine selected from Sulfoxaflor, or Butenolide selected from Flupyradifurone, or Mesoionics selected from Triflumezopyrim.

(5) Nicotinic acetylcholine receptor (nAChR) allosteric activators, preferably Spinosynes selected from Spinetoram and Spinosad.

(6) Allosteric modulators of the glutamate-dependent chloride channel (GluCl), preferablyAvermectine/Milbemycine selected from Abamectin, Emamectin-benzoate, Lepimectin and Milbemectin.

(7) Juvenile hormone mimetics, preferably Juvenile hormon-analogs selected from Hydropren, Kinopren and Methopren, or Fenoxycarb or Pyriproxyfen.

(8) Various non-specific (multi-site) inhibitors, preferably Alkylhalogenides selected from Methylbromide and other Alkylhalogenides, or Chloropicrin or Sulfurylfluorid or Borax or Tartar emetic or Methylisocyanate generators selected from Diazomet and Metam.

(9) TRPV channel modulators of chordotonal organs selected from Pymetrozin and Pyrifluquinazon.

(10) Mite growth inhibitors selected from Clofentezin, Hexythiazox, Diflovidazin and Etoxazol.

(11) Microbial disruptors of the insect intestinal membrane selected from Bacillus thuringiensis Subspezies israelensis, Bacillus sphaericus, Bacillus thuringiensis Subspezies aizawai, Bacillus thuringiensis Subspezies kurstaki, Bacillus thuringiensis subspecies tenebrionis and B.t.-plant proteins selected from Cry1Ab, Cry1Ac, Cry1Fa, Cry1A.105, Cry2Ab, VIP3A, mCry3A, Cry3Ab, Cry3Bb and Cry34Ab1/35Ab1.

(12) Mitochondrial ATP synthase inhibitors, preferably ATP-disruptors selected from Diafenthiuron, or Organo-tin-compoiunds selected from Azocyclotin, Cyhexatin and Fenbutatin-oxid, or Propargit or Tetradifon.

(13) Decoupler of oxidative phosphorylation by disturbance of the proton gradient selected from Chlorfenapyr, DNOC and Sulfluramid.

(14) Nicotinic acetylcholine receptor channel blocker selected from Bensultap, Cartap-hydrochlorid, Thiocyclam and Thiosultap-Sodium.

(15) Inhibitors of chitin biosynthesis, Typ 0, selected from Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron.

(16) Inhibitors of chitin biosynthesis, Typ 1 selected from Buprofezin.

(17) Molting disruptor (especially for dipteras, i.e. two-winged insects) selected from Cyromazin.

(18) Ecdyson receptor agonists selected from Chromafenozid, Halofenozid, Methoxyfenozid and Tebufenozid.

(19) Octopamin-receptor-agonists selected from Amitraz.

(20) Mitochondrial complex III electron transport inhibitors selected from Hydramethylnon, Acequinocyl and Fluacrypyrim.

(21) Mitochondrial complex I electron transport inhibitors, preferably so-called METI-acaricides selected from Fenazaquin, Fenpyroximat, Pyrimidifen, Pyridaben, Tebufenpyrad and Tolfenpyrad, or Rotenon (Derris).

(22) Blocker of the voltage-dependent sodium channel selected from Indoxacarb and Metaflumizone.

(23) Inhibitors of acetyl-CoA carboxylase, preferably tetronic and tetramic acid derivatives selected from Spirodiclofen, Spiromesifen, Spirotetramat and Spidoxamate (IUPAC Name: 11-(4-chloro-2,6-xylyl)-12-hydroxy-1,4-dioxa-9-azadispiro[4.2.4.2]tetradec-11-en-10-one).

(24) Mitochondrial complex IV electron transport inhibitors, preferably Phosphines selected from Aluminiumphosphid, Calciumphosphid, Phosphin and Zinkphosphid, or Cyanides selected from Calciumcyanid, Potassiumcyanid and Sodiumcyanid.

(25) Mitochondrial complex II electron transport inhibitors, preferablybeta-Ketonitrilderivate selected from Cyenopyrafen and Cyflumetofen, or Carboxanilide selected from Pyflubumid.

(28) Ryanodinreceptor-modulators, preferably Diamide selected from Chlorantraniliprol, Cyantraniliprol and Flubendiamid.

(29) Modulators of chordotonal organs (with undefined target structure) selected from Flonicamid.

(30) other active ingredients selected from Acynonapyr, Afidopyropen, Afoxolaner, Azadirachtin, Benclothiaz, Benzoximat, Benzpyrimoxan, Bifenazat, Broflanilid, Bromopropylat, Chinomethionat, Chloroprallethrin, Cryolit, Cyclaniliprol, Cycloxaprid, Cyhalodiamid, Dicloromezotiaz, Dicofol, Dimpropyridaz, epsilon-Metofluthrin, epsilon-Momfluthrin, Flometoquin, Fluazaindolizin, Fluensulfon, Flufenerim, Flufenoxystrobin, Flufiprol, Fluhexafon, Fluopyram, Flupyrimin, Fluralaner, Fluxametamid, Fufenozid, Guadipyr, Heptafluthrin, Imidaclothiz, Iprodione, Isocycloseram, kappa-Bifenthrin, kappa-Tefluthrin, Lotilaner, Meperfluthrin, Oxazosulfyl, Paichongding, Pyridalyl, Pyrifluquinazon, Pyriminostrobin, Spirobudiclofen, Spiropidion, Tetramethylfluthrin, Tetraniliprol, Tetrachlorantraniliprol, Tigolaner, Tioxazafen, Thiofluoximat and Iodmethan; products from Bacillus firmus (1-1582, BioNeem, Votivo), as well as following compounds: 1-{2-Fluor-4-methyl-5-[(2,2,2-trifluorethyl)sulfinyl]phenyl}-3-(trifluormethyl)-1H-1,2,4-triazol-5-amin (known from WO2006/043635) (CAS 885026-50-6), {1′-[(2E)-3-(4-Chlorphenyl)prop-2-en-1-yl]-5-fluorspiro[indol-3,4′-piperidin]-1(2H)-yl}(2-chlorpyridin-4-yl)methanon (known from WO2003/106457) (CAS 637360-23-7), 2-Chlor-N-[2-{1-[(2E)-3-(4-chlorphenyl)prop-2-en-1-yl]piperidin-4-yl}-4-(trifluormethyl)phenyl]isonicotinamid (known from WO2006/003494) (CAS 872999-66-1), 3-(4-Chlor-2,6-dimethylphenyl)-4-hydroxy-8-methoxy-1,8-diazaspiro[4.5]dec-3-en-2-on (known from WO2010052161) (CAS 1225292-17-0), 3-(4-Chlor-2,6-dimethylphenyl)-8-methoxy-2-oxo-1,8-diazaspiro[4.5]dec-3-en-4-yl-ethylcarbonat (known from EP 2647626) (CAS-1440516-42-6), 4-(But-2-in-1-yloxy)-6-(3,5-dimethylpiperidin-1-yl)-5-fluoropyrimidin (known from WO2004/099160) (CAS 792914-58-0), PF1364 (known from JP2010/018586) (CAS-Reg.No. 1204776-60-2), (3E)-3-[1-[(6-Chlor-3-pyridyl)methyl]-2-pyridyliden]-1,1,1-trifluorpropan-2-on (known from WO2013/144213) (CAS 1461743-15-6), N-[3-(Benzylcarbamoyl)-4-chlorphenyl]-1-methyl-3-(pentafluorethyl)-4-(trifluormethyl)-1H-pyrazol-5-carboxamid (known from WO2010/051926) (CAS 1226889-14-0), 5-Brom-4-chlor-N-[4-chlor-2-methyl-6-(methylcarbamoyl)phenyl]-2-(3-chlor-2-pyridyl)pyrazol-3-carboxamid (known from CN103232431) (CAS 1449220-44-3), 4-[5-(3,5-Dichlorphenyl)-4,5-dihydro-5-(trifluormethyl)-3-isoxazolyl]-2-methyl-N-(cis-1-oxido-3-thietanyl)benzamid, 4-[5-(3,5-Dichlorphenyl)-4,5-dihydro-5-(trifluormethyl)-3-isoxazolyl]-2-methyl-N-(trans-1-oxido-3-thietanyl)benzamid and 4-[(5S)-5-(3,5-Dichlorphenyl)-4,5-dihydro-5-(trifluormethyl)-3-isoxazolyl]-2-methyl-N-(cis-1-oxido-3-thietanyl)benzamid (known from WO 2013/050317 A1) (CAS 1332628-83-7), N-[3-Chlor-1-(3-pyridinyl)-1H-pyrazol-4-yl]-N-ethyl-3-[(3,3,3-trifluorpropyl)sulfinyl]propanamid, (+)-N-[3-Chlor-1-(3-pyridinyl)-1H-pyrazol-4-yl]-N-ethyl-3-[(3,3,3-trifluorpropyl)sulfinyl]propanamid and (−)-N-[3-Chlor-1-(3-pyridinyl)-1H-pyrazol-4-yl]-N-ethyl-3-[(3,3,3-trifluorpropyl)sulfinyl]propanamid (known from WO 2013/162715 A2, WO 2013/162716 A2, US 2014/0213448 A1) (CAS 1477923-37-7), 5-[[(2E)-3-Chlor-2-propen-1-yl]amino]-1-[2,6-dichlor-4-(trifluormethyl)phenyl]-4-[(trifluormethyl)sulfinyl]-1H-pyrazol-3-carbonitrile (known from CN 101337937 A) (CAS 1105672-77-2), 3-Brom-N-[4-chlor-2-methyl-6-[(methylamino)thioxomethyl]phenyl]-1-(3-chlor-2-pyridinyl)-1H-pyrazol-5-carboxamid, (Liudaibenjiaxuanan, known from CN 103109816 A) (CAS 1232543-85-9); N-[4-Chlor-2-[[(1,1-dimethylethyl)amino]carbonyl]-6-methylphenyl]-1-(3-chlor-2-pyridinyl)-3-(fluormethoxy)-1H-pyrazol-5-carboxamid (known from WO 2012/034403 A1) (CAS 1268277-22-0), N-[2-(5-Amino-1,3,4-thiadiazol-2-yl)-4-chlor-6-methylphenyl]-3-brom-1-(3-chlor-2-pyridinyl)-1H-pyrazol-5-carboxamid (known from WO 2011/085575 A1) (CAS 1233882-22-8), 4-[3-[2,6-Dichlor-4-[(3,3-dichlor-2-propen-1-yl)oxy]phenoxy]propoxy]-2-methoxy-6-(trifluormethyl)pyrimidin (known from CN 101337940 A) (CAS 1108184-52-6); (2E)- and 2(Z)-2-[2-(4-Cyanophenyl)-1-[3-(trifluormethyl)phenyl]ethyliden]-N-[4-(difluormethoxy)phenyl]hydrazincarboxamid (known from CN 101715774 A) (CAS 1232543-85-9); Cyclopropancarbonsaure-3-(2,2-dichlorethenyl)-2,2-dimethyl-4-(1H-benzimidazol-2-yl)phenylester (known from CN 103524422 A) (CAS 1542271-46-4); (4aS)-7-Chlor-2,5-dihydro-2-[[(methoxycarbonyl)[4-[(trifluormethyl)thio]phenyl]amino]carbonyl]indeno[1,2-e][1,3,4]oxadiazin-4a(3H)-carbonsauremethylester (known from CN 102391261 A) (CAS 1370358-69-2); 6-Desoxy-3-O-ethyl-2,4-di-O-methyl-1-[N-[4-[1-[4-(1,1,2,2,2-pentafluorethoxy)phenyl]-1H-1,2,4-triazol-3-yl]phenyl]carbamat]-α-L-mannopyranose (known from US 2014/0275503 A1) (CAS 1181213-14-8); 8-(2-Cyclopropylmethoxy-4-trifluormethylphenoxy)-3-(6-trifluormethylpyridazin-3-yl)-3-azabicyclo[3.2.1]octan (CAS 1253850-56-4), (8-anti)-8-(2-Cyclopropylmethoxy-4-trifluormethylphenoxy)-3-(6-trifluormethylpyridazin-3-yl)-3-azabicyclo[3.2.1]octan (CAS 933798-27-7), (8-syn)-8-(2-Cyclopropylmethoxy-4-trifluormethylphenoxy)-3-(6-trifluormethylpyridazin-3-yl)-3-azabicyclo[3.2.1]octan (known from WO2007040280 A1, WO2007040282 A1) (CAS 934001-66-8), N-[3-Chlor-1-(3-pyridinyl)-1H-pyrazol-4-yl]-N-ethyl-3-[(3,3,3-trifluorpropyl)thio]-propanamid (known from WO 2015/058021 A1, WO 2015/058028 A1) (CAS 1477919-27-9) and N-[4-(Aminothioxomethyl)-2-methyl-6-[(methylamino)carbonyl]phenyl]-3-bromo-1-(3-chloro-2-pyridinyl)-1H-pyrazol-5-carboxamid (known from CN 103265527 A) (CAS 1452877-50-7), 5-(1,3-Dioxan-2-yl)-4-[[4-(trifluormethyl)phenyl]methoxy]-pyrimidin (known from WO 2013/115391 A1) (CAS 1449021-97-9), 3-(4-Chlor-2,6-dimethylphenyl)-8-methoxy-1-methyl-1,8-diazaspiro[4.5]decane-2,4-dion (known from WO 2014/187846 A1) (CAS 1638765-58-8), 3-(4-Chlor-2,6-dimethylphenyl)-8-methoxy-1-methyl-2-oxo-1,8-diazaspiro[4.5]dec-3-en-4-yl-carbonsaureethylester (known from WO 2010/066780 A1, WO2011151146 A1) (CAS 1229023-00-0), 4-[(5S)-5-(3,5-Dichlor-4-fluorophenyl)-4,5-dihydro-5-(trifluoromethyl)-3-isoxazolyl]-N-[(4R)-2-ethyl-3-oxo-4-isoxazolidinyl]-2-methyl-benzamid (known from WO 2011/067272, WO2013/050302) (CAS 1309959-62-3).

The at least one active ingredient is preferably selected from the group comprising insecticides selected from the group comprising classes as described here above (2 GABA-gated chloride channel antagonists, (3) Sodium channel modulators/voltage-dependent sodium channel blockers (4) (4) Nicotinic acetylcholine receptor (nAChR) competitive activators, (23) Inhibitors of acetyl-CoA carboxylase, (28) Ryanodinreceptor-modulators, (30) other active ingredients.

Further preferred, the at least one active ingredient a) is selected from the group comprising spirotetramat, spiromesifen, spidoxamate (IUPAC Name: 11-(4-chloro-2,6-xylyl)-12-hydroxy-1,4-dioxa-9-azadispiro[4.2.4.2]tetradec-11-en-10-one), flubendiamide, tetraniliprole, deltamethrin, ß-cyfluthrin, imidacloprid, thiacloprid, ethiprole, fipronil, fluopyram and flupyradifurone.

All named insecticides of the classes (1) to (30) as described here above can be present in the form of the free compound or, if their functional groups enable this, an agrochemically active salt thereof.

Furthermore, mesomeric forms as well as stereoisomers or enantiomers, where applicable, shall be enclosed, as these modifications are well known to the skilled artisan, as well as polymorphic modifications.

If not otherwise specified, in the present invention solid, agrochemical active compounds a) are to be understood as meaning all substances customary for plant treatment, whose melting point is above 20° C.

In a preferred embodiment only one active ingredient as insecticide is present.

In another the formulation contains as a) a mixture of two insecticides.

In an alternative embodiment the formulation contains as a) an insecticideand as mixing partner a further active ingredient selected from the group of fungicides, herbicides and safeners.

Organosilicone-Based Surfactants (b)

Suitable organosilicone ethoxylates are organomodified polysiloxanes/trisiloxane alkoxylates with the following CAS No. 27306-78-1, 67674-67-3, 134180-76-0, e.g., Silwet® L77, Silwet® 408, Silwet® 806, BreakThru® S240, BreakThru® S278;

Preferred are polyalkyleneoxide modified heptamethyltrisiloxane, more preferred selected from the group comprising the siloxane groups Poly(oxy-1,2-ethanediyl), alpha-methyl-omega-[3-[1,3,3,3-tetramethyl-1-[(trimethylsilyl)oxy]disiloxanyl]propoxy] (CAS No (27306-78-1), Poly(oxy-1,2-ethanediyl), alpha-[3-[1,3,3,3-tetramethyl-1-[(trimethylsilyl)oxy]disiloxanyl]propyl]-omega.-hydroxy (Cas No 67674-67-3), and Oxirane, methyl-, polymer with oxirane, mono3-1,3,3,3-tetramethyl-1-(trimethylsilyl)oxydisiloxanylpropyl ether (Cas No 134180-76-0).

Other Formulants (c) are

C1 Suitable non-ionic surfactants or dispersing aids c1) are all substances of this type which can customarily be employed in agrochemical agents. Preferably, polyethylene oxide-polypropylene oxide block copolymers, preferably having a molecular weight of more than 6,000 g/mol or a polyethylene oxide content of more than 45%, more preferably having a molecular weight of more than 6,000 g/mol and a polyethylene oxide content of more than 45%, polyethylene glycol ethers of branched or linear alcohols, reaction products of fatty acids or fatty acid alcohols with ethylene oxide and/or propylene oxide, furthermore polyvinyl alcohol, polyoxyalkylenamine derivatives, polyvinylpyrrolidone, copolymers of polyvinyl alcohol and polyvinylpyrrolidone, and copolymers of (meth)acrylic acid and (meth)acrylic acid esters, furthermore branched or linear alkyl ethoxylates and alkylaryl ethoxylates, where polyethylene oxide-sorbitan fatty acid esters may be mentioned by way of example. Out of the examples mentioned above selected classes can be optionally phosphated, sulphonated or sulphated and neutralized with bases.

Possible anionic surfactants c1) are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid. Mono- and diesters of sulfosuccinate metal salts with branched or linear alcohols comprising 1-10 carbon atoms, in particular alkali metal salts, more particular sodium salts, and most particular sodium dioctylsulfosuccinate.

C2 A rheological modifier is an additive that when added to the recipe at a concentration that reduces the gravitational separation of the dispersed active ingredient during storage results in a substantial increase in the viscosity at low shear rates. Low shear rates are defined as 0.1 s⁻¹ and below and a substantial increase as greater than x2 for the purpose of this invention. The viscosity can be measured by a rotational shear rheometer.

Suitable rheological modifiers c2) by way of example are:
Polysaccharides including xanthan gum, guar gum and hydroxyethyl cellulose. Examples are Kelzan®, Rhodopol® G and 23, Satiaxane® CX911 and Natrosol® 250 range.
Clays including montmorillonite, bentonite, sepeolite, attapulgite, laponite, hectorite. Examples are Veegum® R, Van Gel® B, Bentone® CT, HC, EW, Pangel® M100, M200, M300, S, M, W, Attagel® 50, Laponite® RD,
Fumed and precipitated silica, examples are Aerosil® 200, Sipernat® 22.

Preferred are xanthan gum, montmorillonite clays, bentonite clays and fumed silica.

C3 Suitable antifoam substances c3) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® fron Silchem, Foam-Clear ArraPro-S® from Basildon Chemical Company Ltd, SAG© 1572 and SAG© 30 from Momentive [Dimethyl siloxanes and silicones, CAS No. 63148-62-9]. Preferred is SAG© 1572.

C4 Suitable other formulants c4) are selected from biocides, antifreeze, colourants, pH adjusters, buffers, stabilisers, antioxidants, humectants, crystal growth inhibitors, micronutirients by way of example are:

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1,2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Suitable antifreeze substances are all substances which can customarily be employed in agrochemical agents for this purpose. Suitable examples are propylene glycol, ethylene glycol, urea and glycerine.

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na₂HPO₄), sodium dihydrogen phosphate (NaH₂PO₄), potassium dihydrogen phosphate (KH₂PO₄), potassium hydrogen phosphate (K₂HPO₄), may be mentioned by way of example.

Suitable stabilisers and antioxidants are all substances which can customarily be employed in agrochemical agents for this purpose. Butylhydroxytoluene [3,5-Di-tert-butyl-4-hydroxytoluol, CAS-No. 128-37-0] is preferred.

Carriers (d) are those which can customarily be used for this purpose in agrochemical formulations.

A carrier is a solid or liquid, natural or synthetic, organic or inorganic substance that is generally inert, and which may function as a solvent. The carrier generally improves the application of the compounds, for instance, to plants, plants parts or seeds. Examples of suitable

solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include but are not limited to crushed and fractionated natural rocks such as calcite, marble, pumice, sepiolite and dolomite, synthetic granules of inorganic and organic flours and granules of organic material such as paper, sawdust, coconut shells, maize cobs and tobacco stalks.

Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of
aromatic and nonaromatic hydrocarbons (such as cyclohexane, paraffins, alkylbenzenes, xylene, toluene, tetrahydronaphthalene, alkylnaphthalenes, chlorinated aromatics or chlorinated aliphatic hydrocarbons such as chlorobenzenes, chloroethylenes or methylene chloride),
alcohols and polyols (which may optionally also be substituted, etherified and/or esterified, such as ethanol, propanol, butanol, benzylalcohol, cyclohexanol or glycol, 2-ethyl hexanol),
ethers such as dioctyl ether, tetrahydrofuran, dimethyl isosorbide, solketal, cyclopentyl methyl ether, solvents offered by Dow under the Dowanol Product Range e.g. Dowanol DPM, anisole, phenetole, different molecular weight grades of dimethyl polyethylene glycol, different molecular weight grades of dimethyl polypropylene glycol, dibenzyl ether
ketones (such as acetone, methyl ethyl ketone, methyl isobutyl ketone, cyclopentanone, cyclohexanone, cycloheptanone, acetophenone, propiophenone),
esters (also including methylated fats and oils such as rapeseed oil methyl ester, soybean oil methyl ester, coconut oil methyl ester, 2-ethyl hexyl palmitate, 2-ethyl hexyl stearate), such as butyl propionate, pentyl propionate, methyl hexanoate, methyl octanoate, methyl decanoate, 2-ethyl-hexyl acetate, benzyl acetate, cyclohexyl acetate, isobornyl acetate, benzyl benzoate, butyl benzoate, isopropyl benzoate, dimethyl succinate, dimethyl glutarate, dimethyl adipate, diisopropyl adipate, dibutyl adipate, Benzyl-2-ethylhexyl adipate, dimethyl 2-methyl glutarate, monoacetin, diacetin, triacetin, trimethyl citrate, triethyl citrate, triethyl acetyl citrate, tributyl citrate, tributyl acetyl citrate -lactate esters, such as methyl lactate, ethyl lactate, propyl lactate, butyl lactate, 2-ethyl hexyl lactate -(poly)ethers such as different molecular weight grades of polyethylene glycol, different molecular weight grades of polypropylene glycol
unsubstituted and substituted amines
amides (such as dimethylformamide, or N,N-dimethyl lactamide, or N-formyl morpholine, or fatty acid amides such N,N-dimethyl decanamide or N,N-dimethyl dec-9-en-amide) and esters thereof
lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam)
lactones (such as gamma-butyrolactone, gamma-valerolactone, delta-valerolactone, or alpha-methyl gamma-butyrolactone
sulfones and sulfoxides (such as dimethyl sulfoxide),
oils of vegetable or animal origin such as sunflower oil, rapeseed oil, corn oil
nitriles, such as linear or cyclic alkyl nitriles, in particular acetonitrile, cyclohexane carbonitrile, octanonitrile, dodecanonitrile).
linear and cyclic carbonates, such as diethyl carbonate, dipropyl carbonate, dibutyl carbonate, dioctyl carbonate, or ethylene carbonate, propylene carbonate, butylene carbonate, glycerine carbonate
phosphates, such as triethyl phosphate, tributyl phosphate, triisobutyl phosphate, trioctyl phosphate, tris(2-ethyl hexyl) phosphate
white mineral oils
Mixtures of the above like RPDE, FMPC A128 1221 “crodamol OP cegesoft 24” CETIOL® 868, Match 111, Rhodiasol green/25, Miglyol 812N, Agnique ME 610, Agnique ME 890

As liquid carrier water is most preferred in one embodiment.

These spray liquids are applied by customary methods, i.e., for example, by spraying, pouring or injecting, in particular by spraying, and most particular by spraying by UAV.

The application rate of the formulations according to the invention can be varied within a relatively wide range. It is guided by the particular active agrochemicals and by their amount in the formulations.

With the aid of the formulations according to the invention it is possible to deliver active agrochemical to plants and/or their habitat in a particularly advantageous way.

The present invention is also directed to the use of agrochemical compositions according to the invention for the application of the agrochemical active compounds contained to plants and/or their habitat.

With the formulations of the invention it is possible to treat all plants and plant parts. By plants here are meant all plants and plant populations, such as desirable and unwanted wild plants or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material.

What may be emphasized in this context is the particularly advantageous effect of the formulations according to the invention with regard to their use in cereal plants such as, for example, wheat, oats, barley, spelt, triticale and rye, but also in maize, sorghum and millet, rice, sugar cane, soya beans, sunflowers, potatoes, cotton, oilseed rape, canola, tobacco, sugar beet, fodder beet, asparagus, hops and fruit plants (comprising pome fruit such as, for example, apples and pears, stone fruit such as, for example, peaches, nectarines, cherries, plums and apricots, citrus fruits such as, for example, oranges, grapefruits, limes, lemons, kumquats, tangerines and satsumas, nuts such as, for example, pistachios, almonds, walnuts and pecan nuts, tropical fruits such as, for example, mango, papaya, pineapple, dates and bananas, and grapes) and vegetables (comprising leaf vegetables such as, for example, endives, corn salad, Florence fennel, lettuce, cos lettuce, Swiss chard, spinach and chicory for salad use, cabbages such as, for example, cauliflower, broccoli, Chinese leaves, Brassica oleracea (L.) convar. acephala var. sabellica L. (curly kale, feathered cabbage), kohlrabi, Brussels sprouts, red cabbage, white cabbage and Savoy cabbage, fruit vegetables such as, for example, aubergines, cucumbers, capsicums, table pumpkins, tomatoes, courgettes and sweetcorn, root vegetables such as, for example celeriac, wild turnips, carrots, including yellow cultivars, Raphanus sativus var. niger and var. radicula, beetroot, scorzonera and celery, legumes such as, for example, peas and beans, and vegetables from the Allium family such as, for example, leeks and onions.

The treatment of the plants and plant parts in accordance with the invention with the inventive formulations is carried out directly or by action on their environment, habitat or storage area in accordance wih the customary treatment methods, for example by dipping, spraying, vaporizing, atomizing, broadcasting or painting on and, in the case of propagation material, especially seeds, additionally by single or multiple coating.

The active agrochemicals comprised develop a better biological activity than when applied in the form of the corresponding conventional formulations.

Leaf surfaces (new corrected version including tables—to replace all other versions) In Tables 1a and 1b the contact angle of water on leaf surfaces for textured and non-textured is shown.

Table 1a Plants with textured leaves

TABLE 1a
Plants with textured leaves

| | | Contact angle of |
|---|---|---|
| Plant | Species | water ° (adaxial) |
| barley | Hordeum vulgare | 143° |
| | (var. Montoya) | |
| corn, BBCH-11 | Zea mays | 150° |
| corn, BBCH-12 | Zea mays | 149° |
| corn, BBCH-13/14 | Zea mays | 148° |
| soybean, BBCH-12 | Glycine max | 149° |
| soybean, BBCH-13 | Glycine max | 144° |
| rice | Oryza sativa | 180° |
| wheat, BBCH-12 | Triticum aestivum | 148° |
| fat-hen | Chenopodium album | 137° |
| purple crabgrass | Digitaria sanguinalis | 144° |

Table 1b
Plants with non-textured leaves

| | | Contact angle of |
|---|---|---|
| Plant | Species | water ° (adaxial) |
| apple | Malus domestica | 104° |
| tomato | Solanum lycopersicum | 106° |
| corn, BBCH-15/16 | Zea mays | 108° |
| corn, BBCH-17 | Zea mays | 107° |
| corn, BBCH-18 | Zea mays | 96° |
| corn, BBCH-19 | Zea mays | 87° |
| velvetleaf | Abutilon theophrasti | 103° |
| redroot pigweed | Amaranthus retroflexus | not measured |

Examples of non-textured crops and plants include tomatoes, peppers, potatoes, carrot, celery, sugar beet, beetroot, spinach, lettuce, beans, peas, clover, apple, pear, peach, apricot, plum, mango, avocado, olive, citrus, orange, lemon, lime, grape, fig, cucumber, melon, water melon, strawberry, raspberry, blueberry, sunflower, pumpkin, soybean (>GS 16 (BBCH 16)), corn (>GS 15 (BBCH 15), cotton.

Examples of textured crops and plants include garlic, onions, leeks, soybean (<GS 16 (BBCH 16)), oats, wheat, barley, rice, sugarcane, pineapple, banana, linseed, lilies, orchids, corn (<GS 15 (BBCH 15)), cabbage, brussels sprouts, broccoli, Cauliflower, rye, rapeseed, tulips and peanut.

Examples of non-textured weeds include Abutilon theophrasti, Capsella bursa-pastoris, Datura stramonium, Galium aparine, Ipomoea purpurea, Polygonum lapathifolium, Portulaca oleracea, Senecio vulgaris, Sida spinosa, Sinapis arvensis, Solanum nigrum, Stellaria media, Xanthium orientale, Cyperus rotundus, and Amaranthus retroflexus.

Examples of textured weeds include Cassia obtusifolia, Chenopodium album, Agropyron repens, Alopecurus myosuroides, Apera spica-venti, Avena fatua, Brachiaria plantaginea, Bromus secalinus, Cynodon dactylon, Digitaria sanguinalis, Echinochloa crus-galli, Panicum dichotomiflorum, Poa annua, Setariafaberi and Sorghum halepense.

### FIGURES

FIG. 1 shows scanning electron micrographs of leaf surface textures, wherein the upper picture shows a grapevine leaf surface (untextured) and the lower picture shows a soybean leaf surface (textured)

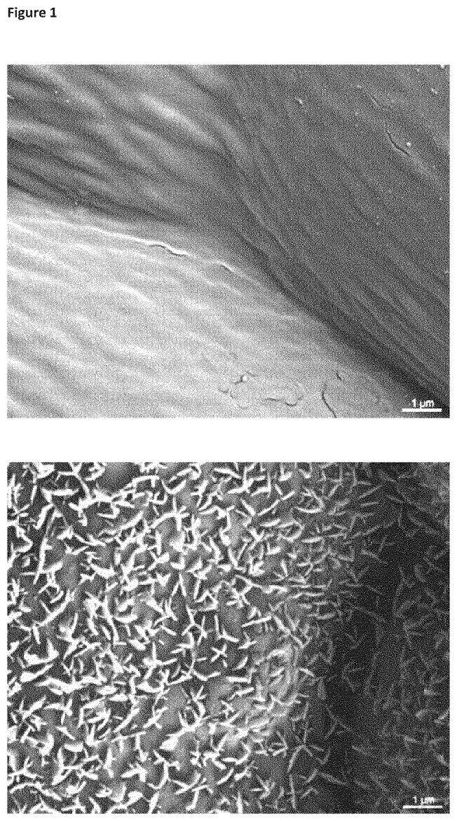

Since soy and corn change leaf properties over their lifetime, according to the present invention the treatment in regard to leaf properties can be adapted, i.e. the formulations according to the invention can be applied in a growth stadium where the leafs are hard to wet.

The invention is illustrated by the following examples.

### EXAMPLES

Method 1: SC Preparation

The method of the preparation of suspension concentrate formulations are known in the art and can be produced by known methods familiar to those skilled in the art. A 2% gel of the xanthan (c) in water and the biocides (c) was prepared with low shear stirring. The active ingredient (a), non-ionic and anionic dispersants (c), antifoam (c) and other formulants (c) were mixed with water to form a slurry, first mixed with a high shear rotor-stator mixer (Ultra-Turrax*) to reduce the particle size D(v,0.9) to approximately 50 microns, then passed through one or more bead mills (Eiger® 250 Mini Motormill) to achieve a particles size D(v,0.9) typically 1 to 15 microns. Then the polyalkyleneoxide modified heptamethyltrisiloxane (b) and xanthan gel prepared above were added and mixed in with low shear stirring until homogeneous. Finally, the pH is adjusted if needed with acid or base (c).

Method 2: WG Preparation

The methods of the preparation water dispersible granule formulations are known in the art and can be produced by known methods familiar to those skilled in the art.

For example, to produce a fluid bed granule first a water-based technical concentrate has to be prepared. With low shear stirring all ingredients (a, b and c) like e.g. the active ingredient, surfactants, dispersants, binder, antifoam, spreader, and filler are mixed in water and finally pre-milled in a high shear rotor-stator mixer (Ultra-Turrax*) to reduce the particle size D(v,0.9) to approximately 50 microns, afterwards passed through one or more bead mills (KDL, Bachofen, Dynomill, Bihler, Drais, Lehmann) to achieve a particles size D(v,0.9) typically 1 to 15 microns. This water-based technical concentrate is then spray-dried in a fluid-bed granulation process to form the wettable granules (WG).

The particle size is determined according to CIPAC (CIPAC=Collaborative International Pesticides Analytical Council; www.cipac.org) method MT 187. The particle size distribution is determined by means of laser diffraction. A representative amount of sample is dispersed in degassed water at ambient temperature (self-saturation of the sample), treated with ultrasound (usually 60 s) and then measured in a device from the Malvern Mastersizer series (Malvern Panalytical). The scattered light is measured at various angles using a multi-element detector and the associated numerical values are recorded. With the help of the Fraunhofer model, the proportion of certain size classes is calculated from the scatter data and from this a volume-weighted particle size distribution is calculated. Usually the d50 or d90 value=active ingredient particle size (50 or 90% of all volume particles) is given. The average particle size denotes the d50 value.

Likewise, any other spraying process, like e.g. classical spray drying can be used as granulation method.

A further technique to produce water dispersible granules is for example low pressure extrusion. The ingredients of the formulation are mixed in dry from and are subsequently milled, e.g. using air-jet milling to reduce the particle size. Subsequently this dry powder is stirred while water is added to the mixture (approximately 10-30 wt %, dependent on the composition of the formulation). In a further step the mixture is pushed through an extruder (like a dome extruder, double dome extruder, basket extruder, sieve mill, or similar device) with a die size of usually between 0.8 and 1.2 mm to form the extrudates. In a last step the extrudates are post-dried, e.g. in a fluidized bed dryer to reduce the water content of the powder, commonly to a level of 1-3 wt % of residual water.

Method 3: EC Preparation

The method of the preparation of EC formulations are known in the art and can be produced by known methods familiar to those skilled in the art. In general, EC formulations are obtained by mixing the active ingredient (a) with the rest of the formulation components, which include, amongst others, surfactants (c), spreader (b), a carrier (d) in a vessel equipped with a stirring device. In some cases the dissolving or mixing was facilitated by raising the temperature slightly (not exceeding 60° C.). Stirring is continued until a homogeneous mixture has been obtained.

Method 4: OD Preparation

Formulation components (c), carrier (d) active ingredient (a), spreader (b) are weighed in, homogenized with a high-shear device (e.g. Ultraturrax or colloidal mill) and subsequently milled in a bead mill (e.g. Dispermat SL50, 80% filling, 1.0-1.25 mm glass beads, 4000 rpm, circulation grinding) until a particle size of <10p is achieved. Alternatively, formulation components are mixed in a bottle followed by addition of approx. 25vol.-% of 1.0-1.25 mm glass beads. The bottle is then closed, clamped in an agitator apparatus (e.g. Retsch MM301) and treated at 30 Hz for several minutes until a particle size of <10p is achieved.

Method 5: Coverage

Greenhouse plants in the development stage as indicated in Tables 1a&1b were used for these experiments. Single leaves were cut just before the spraying experiment, placed into petri dishes and attached by tape at both tips at 0° (horizontally) or at 600 (so that 50% of leaf area can be sprayed). The leaves were carried with caution to avoid damage of the wax surface. These horizontally orientated leaves were either a) placed into a spay chamber where the spray liquid was applied via a hydraulic nozzle or b) a 4 μL drop of spray liquid was pipetted on top without touching the leaf surface.

A small amount of UV dye was added to the spray liquid to visualize the spray deposits under UV light. The concentration of the dye has been chosen such that it does not influence the surface properties of the spray liquid and does not contribute to spreading itself. Tinopal OB as a colloidal suspension was used for all flowable and solid formulation such as WG, SC, OD and SE. Tinopal CBS-X or Blankophor SOL were used for formulations where active ingredient is dissolved such as EC, EW and SL. The Tinopal CBS-X was dissolved in the aqueous phase and the Blankophor SOL dissolved in the oil phase.

After evaporation of the spray liquid, the leaves were placed into a Camag, Reprostar 3 UV chamber where pictures of spray deposits were taken under visual light and under UV light at 366 nm. A Canon EOS 700D digital camera was attached to the UV chamber and used to acquire images the leaves. Pictures taken under visual light were used to subtract the leaf shape from the background. ImageJ software was used to calculate either a) the percentage coverage of the applied spray for sprayed leaves or b) spread area for pipetted drops in mm².

Method 6: Insecticide Greenhouse Tests

Insecticide Greenhouse Tests

Selected crops were grown under greenhouse conditions in plastic pots containing “peat soil T”. At appropriate crop stage, plants were prepared for the treatments, e.g. by infestation with target pest approximately 2 days prior to treatment (s. table below).

Spray solutions were prepared with different doses of active ingredient directly by dilution of formulations with tap water and addition of appropriate amount of additives in tank mix, where required.

The application was conducted with track sprayer onto upper side of leaves with 300 1/ha or 10 1/ha application volume. Nozzles used: Lechler's TeeJet TP8003E (for 300 1/ha) and Lechler's 652.246 together with a pulse-width-module (PWM) (for 10 1/ha). For each single dose applied, usually 2 to 5 replicates were simultaneously treated.

After treatment, plants were artificially infested, if needed, and kept during test duration in a greenhouse or climate chamber. The efficacy of the treatments was rated after evaluation of mortality (in general, given in) and/or plant protection (calculated e.g. from feeding damage in comparison to corresponding controls) at different points of time. Only mean values are reported.

The following table shows pests and crops used in the tests.

| | crop | | | English | pest life | test |
|---|---|---|---|---|---|---|
| crop | stage | infestation | pest | name | stage | objective |
| soybean | BBCH12, | after | Nezara | green | 10x | contact |
| | 5 plants | treatment | viridula | stink | nymphs | and oral |
| | in pot | | | bug | N2-N3 | uptake |
| cabbage | BBCH12, | prior to | Myzus | green | mixed | translaminar |
| | 1-leaf | treatment | persicae | peach | pop- | activity |
| | | | | aphid | ulation | |

TABLE 1
Exemplified trade names and CAS-No's of preferred
organosilicone compounds (b)

| Product | Chemical name | Cas No. | Supplier |
|---|---|---|---|
| Silwet ® L77 | 3-(2-methoxyethoxy)propyl-methyl- | 27306-78-1 | Momentive |
| | bis(trimethylsilyloxy)silane | | |
| Silwet ® 408 | 2-[3- | 67674-67-3 | Momentive |
| | [[dimethyl(trimethylsilyloxy)silyl]oxy- | | |
| | methyl- | | |
| | trimethylsilyloxysilyl]propoxy]ethanol | | |
| Silwet ® 806 | 3-[methyl- | 134180-76-0 | Momentive |
| | bis(trimethylsilyloxy)silyl]propan-1- | | |
| | ol;2-methyloxirane;oxirane | | |
| Break-thru ® | 3-[methyl- | 134180-76-0 | Evonik |
| S240 | bis(trimethylsilyloxy)silyl]propan-1- | | |
| | ol;2-methyloxirane;oxirane | | |
| Break-thru ® | 3-(2-methoxyethoxy)propyl-methyl- | 27306-78-1 | Evonik |
| S278 | bis(trimethylsilyloxy)silane | | |
| Silwet ® HS | Polyalkylenoxide Silane | | Momentive |
| 312 | | | |
| Silwet ® HS | Polyalkylenoxide Silane | | Momentive |
| 604 | | | |
| BreakThru ® | Siloxanes and Silicones, cetyl Me, di- | 191044-49-2 | Evonik |
| OE 444 | Me | | |
| BreakThru | 3-[methyl- | 134180-76-0 | Evonik |
| SD260 | bis(trimethylsilyloxy)silyl]propan-1- | | |
| | ol;2-methyloxirane;oxirane | | |
| BreakThru | 3-[methyl- | 134180-76-0 | Evonik |
| S301 | bis(trimethylsilyloxy)silyl]propan-1- | | |
| | ol;2-methyloxirane;oxirane | | |

TABLE 2
Exemplified trade names and CAS-No's of preferred compounds (c)

| Product | Chemical name | Cas No. | Supplier |
|---|---|---|---|
| Lucramul PS 29 | Poly(oxy-1,2-ethanediyl),. | 104376-75-2 | Levaco |
| | alpha.-phenyl-.omega.-hydroxy-, | | |
| | styrenated | | |
| Lucramul PS 54 | Poly(oxy-1,2- | 104376-75-2 | Levaco |
| | ethanediyl), .alpha.- | | |
| | phenyl-.omega.-hydroxy-, | | |
| | styrenated | | |
| Atlox ® 4913 | methyl methacrylate graft | 119724-54-8 | Croda |
| | copolymer with polyethylene | | |
| | glycol | | |
| Antarox B848 | Oxirane, methyl-, polymer with | 9038-95-3 | Solvay |
| | oxirane, monobutyl ether | | |
| Morwet IP | Naphthalenesulfonic acid, bis(1- | 68909-82-0 | Akzo Nobel |
| | methylethyl)-, Me derivs., | | |
| | sodium salts | | |
| Synperonic ® | block-copolymer of polyethylene | 9003-11-6 | Croda |
| PE/F127 | oxide and polypropylene oxide | | |
| Kaolin W | Mica group minerals | 12001-26-2 | Brenntag |
| Oparyl MT 804 | Dibutylnaphthalenesulfonic acid | 25417-20-3 | Gioavanni |
| | sodium salt | | Bozzetto |
| Pergopak M | Urea formaldehyde polymer | 9011-05-6 | Albermale |
| Polyfon T | Lignosulfonic acid, sodium salt | 8061-51-6 | MeadWestvaco |
| Agnique SLS 90 | Sodium dodecyl sulphate | 151-21-3 | BASF |
| Dispersogen SI | Naphthalenesulfonic acid | 9084-06-4 | Clariant |
| | formaldehyde polymer sodium | | |
| | salt | | |
| NANSA EVM | Benzenesulfonic acid, mono- | 68953-96-8 | Huntsman |
| 40/2NDL | C11-13-branched alkyl derivs ., | | |
| | calcium salts | | |
| Emulsogen EL | Castor oil, ethoxylated | 61791-12-6 | Clariant |
| 400 | | | |
| Atlox 4894 | | 308061-37-2 | Croda |
| Soprophor FLK | Poly(oxy-1,2-ethanediyl), alpha.- | 163436-84-8 | Solvay |
| | 2,4,6-tris(1- | | |
| | phenylethyl)phenyl-.omega.- | | |
| | hydroxy-, phosphate, potassium | | |
| | salt | | |
| Morwet D-425 | Sodium naphthalene sulphonate | 577773-56-9 | Akzo Nobel, |
| | formaldehyde condensate | 68425-94-5 | Nouryon |
| | | 9008-63-3 | |
| Rhodasurf 860/P | Alcohols, C9-11-iso-, C10-rich, | 78330-20-8 | Solvay |
| | ethoxylated | | |
| ATLAS ® G | Oxirane, methyl-, polymer with | 9038-95-3 | Croda |
| 5000 | oxirane, monobutyl ether | | |
| Surfynol 440 | 2,4,7,9-Tetramethyldec-5-yne- | 9014-85-1 | Evonik |
| | 4,7-diol, ethoxylated | | |
| Synperonic | Polyethylene-Polypropylene | 9003-11-6 | Croda |
| PE/F127 | Glycol | | |
| Mowiol 8-88 | Polyvinylalkohol | 9002-89-5 | Kuraray |
| Urea | | 57-13-6 | |
| Glycerin | | 56-81-5 | |
| Propylene | 1,2-Propylene glycol | 57-55-6 | |
| Glycol | | | |
| RHODOPOL ® | Polysaccharide | 11138-66-2 | Solvay |
| 23 | | | |
| Aerosil R812S | Silanamine, 1,1,1-trimethyl-N- | 68909-20-6 | Evonik |
| | (trimethylsilyl)-, hydrolysis | | |
| | products with silica | | |
| Aerosil R972 | Silane, dichlorodimethyl-, | 68611-44-9 | Evonik |
| | reaction products with silica | | |
| Sipernat 22 S | synthetic amorphous silica | 112926-00-8 | Evonik |
| | (silicon dioxide) | 7631-86-9 | |
| Veegum R | Smectite-group minerals | 12199-37-0 | |
| SILCOLAPSE ® | Polydimethylsiloxanes and silica | 9016-00-6 | BLUESTAR |
| 426R | | | SILICONES |
| SAG ® 1572 | Dimethyl siloxanes and silicones | 63148-62-9 | Momentive |
| Citric Acid | | 77-92-9 | |
| | | (anhydrous); | |
| | | 5949-29-1 | |
| | | (Monohydrate) | |
| Diammonium | | 7783-28-0 | |
| Hydrogen | | | |
| Phosphate | | | |
| Proxel ® GXL | 1.2-benzisothiazol-3(2H)-one | 2634-33-5 | Arch |
| | | | Chemicals |
| Kathon ® | 5-chloro-2-methyl-4- | 26172-55-4 | Dow |
| CG/ICP | isothiazolin-3-one plus 2-methyl- | plus | |
| | 4-isothiazolin-3-one | 2682-20-4 | |
| Dowanol DPM | Di(propylene glycol) methyl | 34590-94-8 | Dow |
| | ether | | |
| Cyclohexanone | | 108-94-1 | |
| Solvesso ® | Mixture of aromatic | 64742-94-5 | ExxonMobil |
| 200ND | hydrocarbons (C9-C11), | | |
| | naphtalene depleted | | |

TABLE 3
Spirotetramat/Spiromesifen SC Formulations

| | | Recipe 2 | | Recipe 4 |
|---|---|---|---|---|
| | | according | | according |
| Component | Recipe 1 | to the | Recipe 3 | to the |
| (g/L) | reference | invention | reference | invention |
| Spirotetramat | 75 | 75 | — | — |
| Spiromesifen | — | — | 72 | 72 |
| Lucramul PS 29 | 40 | 40 | — | — |
| Lucramul PS 54 | — | — | 10.5 | 10.5 |
| Atlox 4913 | — | — | 31.5 | 31.5 |
| Glycerin | 100 | 100 | 105 | 105 |
| Rhodopol 23 | 3 | 3 | 3.6 | 3.6 |
| Preventol D7 | 0.8 | 0.8 | 0.8 | 0.8 |
| Proxel GXL 20% | 1.2 | 1.2 | 1.2 | 1.2 |
| Silcolapse 426R | 1 | 1 | 1 | 1 |
| Citric Acid | 1 | 1 | 1 | 1 |
| Silwet HS312 | — | 40 | — | 40 |
| | — | — | — | — |
| Water (add to 1 | To | To | To | To |
| litre) | volume | volume | volume | volume |

TABLE 4
Spray dilution droplet size and dose on non-textured leaves.

| | Leaf | | Organosilicone |
|---|---|---|---|
| | coverage @ | Organosilicone | surfactant dose |
| | 0°, % | surfactant dose | % w/v |
| Recipe | apple | g/ha | (g/100 mL) |
| Recipe 1 not | 20.2 | 0 | 0 |
| according to the | | | |
| invention - 10 l/ha | | | |
| Recipe 1 not | 32.7 | 0 | 0 |
| according to the | | | |
| invention - 300 | | | |
| l/ha | | | |
| Recipe 2 | 28.8 | 40 | 0.4 |
| according to the | | | |
| invention - 10 l/ha | | | |
| Recipe 2 | 82.6 | 40 | 0.01 |
| according to the | | | |
| invention - 300 | | | |
| l/ha | | | |

Formulations applied at 11/ha.

The results show that on non-structured leaves the coverage is higher at higher water application volumes.

TABLE 5
Spray dilution droplet size and dose on textured leaves.

[symbol]

[symbol]

indicates data missing or illegible when filed

Formulations applied at 11/ha.

The results show that at 10 L/ha spray volume, the recipe illustrative of the invention shows larger deposit sizes than the recipe not according to the invention.

TABLE 6
Spray dilution droplet size and dose on non-textured leaves.

| | | | | Organo- |
|---|---|---|---|---|
| | Leaf | Leaf | Organo- | silicone |
| | coverage | coverage | silicone | surfactant |
| | @ | @ | surfactant | dose |
| | 0°, % | 0°, % | dose | % w/v |
| Recipe | soybean | barley | g/ha | (g/100 mL) |
| Recipe 1 not | 19.3 | 19.0 | 0 | 0 |
| according to | | | | |
| the invention - | | | | |
| 10 l/ha | | | | |
| Recipe 1 not | 67.4 | 36.6 | 0 | 0 |
| according to | | | | |
| the invention - | | | | |
| 300 l/ha | | | | |
| Recipe 2 | 38.4 | 39.3 | 40 | 0.4 |
| according to | | | | |
| the invention - | | | | |
| 10 l/ha | | | | |
| Recipe 2 | 89.7 | 80.6 | 40 | 0.01 |
| according to | | | | |
| the invention - | | | | |
| 300 l/ha | | | | |
| | | | | Super- |
| | | | Super- | spreading |
| | | | spreading | surfactant |
| | | Deposit | surfactant | dose |
| | | area mm\hat{ }2 | dose | % w/v |
| | Recipe | apple | g/ha | (g/100 mL) |
| | Recipe 3 not | 7.4 | 0 | 0 |
| | according to | | | |
| | the invention - | | | |
| | 10 l/ha | | | |
| | Recipe 3 not | 6.6 | 0 | 0 |
| | according to | | | |
| | the invention - | | | |
| | 20 l/ha | | | |
| | Recipe 3 not | 3.5 | 0 | 0 |
| | according to | | | |
| | the invention - | | | |
| | 200 l/ha | | | |
| | Recipe 4 | 12.4 | 40 | 0.4 |
| | according to | | | |
| | the invention - | | | |
| | 10 l/ha | | | |
| | Recipe 4 | 11.8 | 40 | 0.2 |
| | according to | | | |
| | the invention - | | | |
| | 20 l/ha | | | |
| | Recipe 4 | 6.6 | 40 | 0.02 |
| | according to | | | |
| | the invention - | | | |
| | 200 l/ha | | | |

TABLE 7
Spray dilution droplet size and dose on textured leaves.

| | | | | | Super- |
|---|---|---|---|---|---|
| | | | | | spreading |
| | | De- | De- | Super- | surfactant |
| | Deposit | posit | posit | spreading | dose |
| | area | area | area | surfactant | % w/v |
| | mm\hat{ }2 | mm\hat{ }2 | mm\hat{ }2 | dose | (g/100 |
| Recipe | soybean | rice | barley | g/ha | mL) |
| Recipe 3 not according | 3.4 | 1.8 | 4.2 | 0 | 0 |
| to the invention - 10 | | | | | |
| l/ha | | | | | |
| Recipe 3 not according | 4.0 | 2.5 | 3.2 | 0 | 0 |
| to the invention - 20 | | | | | |
| l/ha | | | | | |
| Recipe 3 not according | 1.9 | 1.1 | 2.4 | 0 | 0 |
| to the invention - 200 | | | | | |
| l/ha | | | | | |
| Recipe 4 according to | 191.0 | 100.6 | 115.1 | 40 | 0.4 |
| the invention - 10 l/ha | | | | | |
| Recipe 4 according to | 194.2 | 130.6 | 126.2 | 40 | 0.2 |
| the invention - 20 l/ha | | | | | |
| Recipe 4 according to | 8.5 | 7.4 | 14.8 | 40 | 0.02 |
| the invention - 200 l/ha | | | | | |

Formulations applied at 11/ha.

The results show that the recipe illustrative of the invention shows larger deposit sizes at 10 L/ha spray volume than at 200 L/ha, and than the recipe not according to the invention at all water volume uses.

2. SPIDOXAMATE OD

TABLE 8
SPIDOXAMATE OD Formulations

| | | Recipe 6 |
|---|---|---|
| | | according |
| | Recipe 5 | to the |
| Component (g/mL) | reference | invention |
| SPIDOXAMATE | 12 | 12 |
| Antarox B848 | 20 | 20 |
| Propylene Glycol | 150 | 150 |
| Aerosil R812S | 40 | 40 |
| Diammonium Hydrogen | 20 | 20 |
| phosphate | | |
| Silwet HS312 | — | 40 |
| | — | — |
| Dowanol DPM (add to 1 | To volume | To volume |
| litre) | | |

BOP

The leaf deposit size was determined according to coverage method.

TABLE 9
Spray dilution droplet size and dose on non-
textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | apple | g/ha | (g/100 mL) |
| Recipe 5 not according | 6.3 | 0 | 0 |
| to the invention - 10 | | | |
| l/ha | | | |
| Recipe 5 not according | 6.2 | 0 | 0 |
| to the invention - 20 | | | |
| l/ha | | | |
| Recipe 5 not according | 6.0 | 0 | 0 |
| to the invention - 200 | | | |
| l/ha | | | |
| Recipe 6 according to | 12.0 | 40 | 0.4 |
| the invention - 10 l/ha | | | |
| Recipe 6 according to | 7.6 | 40 | 0.2 |
| the invention - 20 l/ha | | | |
| Recipe 6 according to | 5.7 | 40 | 0.02 |
| the invention - 200 l/ha | | | |

Formulations applied at 11/ha.

The results show that on non-structured leaves the deposit size is similar or lower at higher water application volumes.

TABLE 10
Spray dilution droplet size and dose on textured leaves.

| | | | | | Super- |
|---|---|---|---|---|---|
| | | | | | spreading |
| | | De- | De- | Super- | surfactant |
| | Deposit | posit | posit | spreading | dose |
| | area | area | area | surfactant | % w/v |
| | mm\hat{ }2 | mm\hat{ }2 | mm\hat{ }2 | dose | (g/100 |
| Recipe | soybean | rice | barley | g/ha | mL) |
| Recipe 5 not according | 3.4 | 6.6 | 4.5 | 0 | 0 |
| to the invention - 10 | | | | | |
| l/ha | | | | | |
| Recipe 5 not according | 2.9 | 4.1 | 3.0 | 0 | 0 |
| to the invention - 20 | | | | | |
| l/ha | | | | | |
| Recipe 5 not according | 2.1 | 2.4 | 2.5 | 0 | 0 |
| to the invention - 200 | | | | | |
| l/ha | | | | | |
| Recipe 6 according to | 255.7 | 142.5 | 123.9 | 40 | 0.4 |
| the invention - 10 l/ha | | | | | |
| Recipe 6 according to | 141.0 | 103.1 | 119.9 | 40 | 0.2 |
| the invention - 20 l/ha | | | | | |
| Recipe 6 according to | 7.4 | 10.1 | 12.1 | 40 | 0.02 |
| the invention - 200 l/ha | | | | | |

Formulations applied at 11/ha.

The results show that the recipe illustrative of the invention shows larger deposit sizes at 10 L/ha spray volume than at 200 L/ha, and than the recipe not according to the invention at all water volume uses.

3 Flubendiamide, Tetraniliprole SC recipes

TABLE 11
Flubendiamide, Tetraniliprole SC recipes

| | | Recipe 8 | Recipe 9 | Recipe 10 |
|---|---|---|---|---|
| | | according | according | according |
| Component | Recipe 7 | to the | to the | to the |
| (g/L) | reference | invention | invention | invention |
| Tetraniliprole | 40.0 | 40.0 | — | — |
| Flubendiamide | — | — | 120 | 120 |
| Atlox 4913 | 40.0 | 40.0 | — | — |
| Morwet IP | 10.0 | 10.0 | — | — |
| Synperonic | 15.0 | 15.0 | — | — |
| PE/F127 | | | | |
| Lucramul PS 54 | — | — | 12 | 12 |
| Atlox 4913 | — | — | 37 | 37 |
| Citric Acid | 1.0 | 1.0 | — | — |
| Rhodopol 23 | 3.0 | 3.0 | 3.6 | 3.6 |
| Sipernat 22 S | 7.5 | 7.5 | 9 | 9 |
| Silwet ® HS 312 | — | 40 | — | 40 |
| | — | — | — | — |
| Kathon CG/ICP | 0.8 | 0.8 | 1 | 1 |
| Proxel GXL | 1.2 | 1.2 | 1.5 | 1.5 |
| Glycerin | 100.0 | 100.0 | 122 | 122 |
| SAG1572 | 1.5 | 1.5 | 1.8 | 1.8 |
| Water (add to 1 | fill | fill | fill | fill |
| litre) | | | | |

BOP

The leaf deposit size was determined according to coverage method.

TABLE 12
Spray dilution droplet size and dose on non-textured leaves.

| | | | | Organo- |
|---|---|---|---|---|
| | Leaf | Leaf | Organo- | silicone |
| | coverage | coverage | silicone | surfactant |
| | @ | @ | surfactant | dose |
| | 0°, % | 0°, % | dose | % w/v |
| Recipe | apple | abutilon | g/ha | (g/100 mL) |
| Recipe 7 not | 11.7 | 7 | 0 | 0 |
| according to the | | | | |
| invention - 10 l/ha | | | | |
| Recipe 7 not | 30.1 | 23.1 | 0 | 0 |
| according to the | | | | |
| invention - 200 | | | | |
| l/ha | | | | |
| Recipe 8 | 14.2 | 23.0 | 40 | 0.4 |
| according to the | | | | |
| invention - 10 l/ha | | | | |
| Recipe 8 | 74.4 | 55.1 | 40 | 0.02 |
| according to the | | | | |
| invention - 200 | | | | |
| l/ha | | | | |

Formulations applied at 11/ha.

The results show that on non-structured leaves the coverage is higher at higher water application volumes.

TABLE 13
Spray dilution droplet size and dose on textured leaves

| | | | | | Organo- |
|---|---|---|---|---|---|
| | Leaf | Leaf | Leaf | Organo- | silicone |
| | coverage | coverage | coverage | silicone | surfactant |
| | @ | @ | @ | surfactant | dose |
| | 0°, % | 0°, % | 0°, % | dose | % w/v |
| Recipe | soybean | barley | rice | g/ha | (g/100 mL) |
| Recipe 7 not | 6.3 | 5.2 | 5.8 | 0 | 0 |
| according to | | | | | |
| the invention - | | | | | |
| 10 l/ha | | | | | |
| Recipe 7 not | 23.3 | 14.7 | 9.2 | 0 | 0 |
| according to | | | | | |
| the invention - | | | | | |
| 200 l/ha | | | | | |
| Recipe 8 | 23 | 30.6 | 27 | 40 | 0.4 |
| according to | | | | | |
| the invention - | | | | | |
| 10 l/ha | | | | | |
| Recipe 8 | 35.2 | 42.2 | 35 | 40 | 0.02 |
| according to | | | | | |
| the invention - | | | | | |
| 200 l/ha | | | | | |

The results show that at 10 L/ha spray volume, the recipe illustrative of the invention shows larger deposit sizes than the recipe not according to the invention.

TABLE 14
Spray dilution droplet size and dose on non-textured leaves.

| | | | Organosilicone |
|---|---|---|---|
| | Deposit | Organosilicone | surfactant dose |
| | area mm\hat{ }2 | surfactant dose | % w/v |
| Recipe | apple | g/ha | (g/100 mL) |
| Recipe 9 not according | 4.4 | 0 | 0 |
| to the invention - 10 | | | |
| l/ha | | | |
| Recipe 9 not according | 3.1 | 0 | 0 |
| to the invention - 200 | | | |
| l/ha | | | |
| Recipe 10 not | 11.0 | 40 | 0.4 |
| according to the | | | |
| invention - 10 l/ha | | | |
| Recipe 10 according to | 7.5 | 40 | 0.02 |
| the invention - 200 l/ha | | | |

Formulations applied at 11/ha.

The results show that on non-structured leaves the deposit size is similar at both water application volumes.

TABLE 15
Spray dilution droplet size and dose on textured leaves.

| | | | Organosilicone |
|---|---|---|---|
| | Deposit | Organosilicone | surfactant dose |
| | area mm\hat{ }2 | surfactant dose | % w/v |
| Recipe | soybean | g/ha | (g/100 mL) |
| Recipe 9 not according | 1.6 | 0 | 0 |
| to the invention - 10 | | | |
| l/ha | | | |
| Recipe 9 not according | 1.6 | 0 | 0 |
| to the invention - 200 | | | |
| l/ha | | | |
| Recipe 10 not | 196.5 | 40 | 0.4 |
| according to the | | | |
| invention - 10 l/ha | | | |
| Recipe 10 according to | 6.1 | 40 | 0.02 |
| the invention - 200 l/ha | | | |

The results show that the recipe illustrative of the invention shows larger deposit sizes at 10 L/ha spray volume than at 200 L/ha, and than the recipe not according to the invention at all water volume uses.

4. Fubendiamide WG-recipes

TABLE 16
Flubendiamide WG recipes

| | | Recipe 12 | Recipe 13 |
|---|---|---|---|
| | Recipe | according | according |
| Component (% | 11 | to the | to the |
| w/w) | standard | invention | invention |
| Flubendiamide | 24.0 | 22.8 | 23.8 |
| Kaolin W | 44.0 | 41.8 | 43.6 |
| Oparyl MT 804 | 2.0 | 1.9 | 1.9 |
| Pergopak M | 5.0 | 4.8 | 4.9 |
| Polyfon T | 25.0 | 23.7 | 24.8 |
| Break-thru SD 260 | — | 5 | — |
| Break-thru S 301 | — | — | 1 |

BOP

The leaf deposit size was determined according to coverage method.

TABLE 17
Spray dilution droplet size and dose on non-textured leaves.

| | Leaf | | Organosilicone |
|---|---|---|---|
| | coverage @ | Organosilicone | surfactant dose |
| | 0°, % | surfactant dose | % w/v |
| Recipe | apple | g/ha | (g/100 mL) |
| Recipe 11 not | 17.9 | 0 | 0 |
| according to the | | | |
| invention—10 l/ha | | | |
| Recipe 11 not | 39.7 | 0 | 0 |
| according to the | | | |
| invention—200 | | | |
| l/ha | | | |
| Recipe 12 | 15.9 | 8.3 | 0.08 |
| according to the | | | |
| invention—10 l/ha | | | |
| Recipe 12 | 22.8 | 8.3 | 0.004 |
| according to the | | | |
| invention—200 | | | |
| l/ha | | | |
| Recipe 13 | 9.3 | 1.7 | 0.017 |
| according to the | | | |
| invention—10 l/ha | | | |
| Recipe 13 | 23.9 | 1.7 | 0.00085 |
| according to the | | | |
| invention—200 | | | |
| l/ha | | | |

Formulations applied at 40 g ai/ha or 166 g WG/ha.

TABLE 18
Spray dilution droplet size and dose on textured leaves.

| | | | | Organo- |
|---|---|---|---|---|
| | Leaf | Leaf | Organo- | silicone |
| | coverage | coverage | silicone | surfactant |
| | @ | @ | surfactant | dose |
| | 0°, % | 0°, % | dose | % w/v |
| Recipe | soybean | barley | g/ha | (g/100 mL) |
| Recipe 11 not | 4.3 | 4.6 | 0 | 0 |
| according to | | | | |
| the invention—10 | | | | |
| l/ha | | | | |
| Recipe 11 | 2.9 | 1.4 | 0 | 0 |
| not according to | | | | |
| the invention—200 | | | | |
| l/ha | | | | |
| Recipe 12 | 7.8 | 8.3 | 8.3 | 0.08 |
| according to the | | | | |
| invention—10 l/ha | | | | |
| Recipe 12 | 5.1 | 3.4 | 8.3 | 0.004 |
| according to the | | | | |
| invention—200 l/ha | | | | |
| Recipe 13 | 8.2 | 20.0 | 1.7 | 0.017 |
| according to the | | | | |
| invention—10 l/ha | | | | |
| Recipe 13 | 5.4 | 7.4 | 1.7 | 0.00085 |
| according to the | | | | |
| invention—200 l/ha | | | | |

Formulations applied at 40 g ai/ha or 166 g WG/ha.

The results show that the recipes illustrative of the invention show larger deposit sizes on textured leaves at 10 L/ha spray volume than at 200 L/ha, and than the recipe not according to the invention at all water volume uses.

5. Deltamethrin, beta-cyfluthrin SC recipes

TABLE 19
Deltamethrin, beta-cyfluthrin SC recipes

| | | Recipe 15 | | Recipe 17 |
|---|---|---|---|---|
| | | according | Recipe | according |
| | Recipe 14 | to the | 16 | to the |
| Component (g/L) | reference | invention | reference | invention |
| Deltamethrin | 25 | 25 | — | — |
| Beta-Cyfluthrin | — | — | 25 | 25 |
| Agnique SLS 90 | 0.1 | 0.1 | — | — |
| Dispersogen SI | 15 | 15 | — | — |
| Lucramul PS 29 | — | — | 20 | 20 |
| Citric Acid | 0.2 | 0.2 | 0.2 | 0.2 |
| Rhodopol 23 | 4 | 4 | 4 | 4 |
| Sipernat 22 S | 15 | 15 | 30 | 30 |
| Silwet ® HS 312 | — | 40 | — | 40 |
| | — | — | — | — |
| Kathon CG/ICP | 0.8 | 0.8 | 1 | 1 |
| Proxel GXL | 1.2 | 1.2 | 1.5 | 1.5 |
| Glycerin | 150 | 150 | 100 | 100 |
| SAG1572 | 0.5 | 0.5 | 0.5 | 0.5 |
| Water (add to 1 | fill | fill | fill | fill |
| litre) | | | | |

BOP

The leaf deposit size was determined according to coverage method.

TABLE 20
Spray dilution droplet size and dose on non-textured leaves.

| | Deposit | | Organosilicone |
|---|---|---|---|
| | area | Organosilicone | surfactant dose |
| | mm\hat{ }2 | surfactant dose | % w/v |
| Recipe | apple | g/ha | (g/100 mL) |
| Recipe 14 not | 6.0 | 0 | 0 |
| according to the | | | |
| invention—10 l/ha | | | |
| Recipe 14 not | 5.0 | 0 | 0 |
| according to the | | | |
| invention—20 l/ha | | | |
| Recipe 14 not | 2.4 | 0 | 0 |
| according to the | | | |
| invention—200 l/ha | | | |
| Recipe 14 not | 1.6 | 0 | 0 |
| according to the | | | |
| invention—300 l/ha | | | |
| Recipe 15 according to | 12.6 | 20 | 0.2 |
| the invention—10 l/ha | | | |
| Recipe 15 according to | 14.2 | 20 | 0.1 |
| the invention—20 l/ha | | | |
| Recipe 15 according to | 10.4 | 20 | 0.01 |
| the invention—200 l/ha | | | |
| Recipe 15 according to | 8.5 | 20 | 0.007 |
| the invention—300 l/ha | | | |

Formulations applied at 0.5 1/ha.

The results show that on non-structured leaves the deposit size is slightly higher at low water application volumes.

TABLE 21
Spray dilution droplet size and dose on textured leaves.

| | | | | | Organo- |
|---|---|---|---|---|---|
| | | | | Organo- | silicone |
| | Deposit | Deposit | Deposit | silicone | surfactant |
| | area | area | area | surfactant | dose |
| | mm\hat{ }2 | mm\hat{ }2 | mm\hat{ }2 | dose | % w/v |
| Recipe | soybean | rice | barley | g/ha | (g/100 mL) |
| Recipe 14 not | 2.2 | 2.4 | 4.1 | 0 | 0 |
| according to the | | | | | |
| invention—10 l/ha | | | | | |
| Recipe 14 not | 1.8 | 1.3 | 2.5 | 0 | 0 |
| according to the | | | | | |
| invention—20 l/ha | | | | | |
| Recipe 14 not | 0.8 | 0.5 | 1.5 | 0 | 0 |
| according to the | | | | | |
| invention—200 l/ha | | | | | |
| Recipe 14 not | 0.6 | 0.3 | 0.6 | 0 | 0 |
| according to the | | | | | |
| invention—300 l/ha | | | | | |
| Recipe 15 | 232 | 158 | 143 | 20 | 0.2 |
| according to the | | | | | |
| invention—10 l/ha | | | | | |
| Recipe 15 | 219.3 | 140 | 138 | 20 | 0.1 |
| according to the | | | | | |
| invention—20 l/ha | | | | | |
| Recipe 15 | 11.4 | 12.8 | 14.7 | 20 | 0.01 |
| according to the | | | | | |
| invention—200 l/ha | | | | | |
| Recipe 15 | 7.5 | 8.0 | 9.46 | 20 | 0.007 |
| according to the | | | | | |
| invention—300 l/ha | | | | | |

Formulations applied at 0.5 1/ha.

The results show that the recipes illustrative of the invention show larger deposit sizes at 10 L/ha spray volume than at 200 L/ha, and than the recipe not according to the invention at all water volume uses.

TABLE 22
Spray dilution droplet size and dose on non-textured leaves.

| | Deposit | | Organosilicone |
|---|---|---|---|
| | area | Organosilicone | surfactant dose |
| | mm\hat{ }2 | surfactant dose | % w/v |
| Recipe | apple | g/ha | (g/100 mL) |
| Recipe 16 not | 6.8 | 0 | 0 |
| according to the | | | |
| invention—10 l/ha | | | |
| Recipe 16 not | 4.8 | 0 | 0 |
| according to the | | | |
| invention—20 l/ha | | | |
| Recipe 16 not | 1.6 | 0 | 0 |
| according to the | | | |
| invention—200 l/ha | | | |
| Recipe 16 not | 2.1 | 0 | 0 |
| according to the | | | |
| invention—300 l/ha | | | |
| Recipe 17 according to | 13.2 | 20 | 0.2 |
| the invention—10 l/ha | | | |
| Recipe 17 according to | 12.6 | 20 | 0.1 |
| the invention—20 l/ha | | | |
| Recipe 17 according to | 10.3 | 20 | 0.01 |
| the invention—200 l/ha | | | |
| Recipe 17 according to | 7.9 | 20 | 0.007 |
| the invention—300 l/ha | | | |

Formulations applied at 0.5 1/ha.

The results show that on non-structured leaves the deposit size is slightly higher at low water application volumes.

TABLE 23
Spray dilution droplet size and dose on textured leaves.

| | | | | | Organo- |
|---|---|---|---|---|---|
| | | | | Organo- | silicone |
| | Deposit | Deposit | Deposit | silicone | surfactant |
| | area | area | area | surfactant | dose |
| | mm\hat{ }2 | mm\hat{ }2 | mm\hat{ }2 | dose | % w/v |
| Recipe | soybean | rice | barley | g/ha | (g/100 mL) |
| Recipe 16 not | 3.0 | 3.0 | 3.4 | 0 | 0 |
| according to the | | | | | |
| invention—10 l/ha | | | | | |
| Recipe 16 not | 3.5 | 2.6 | 3.8 | 0 | 0 |
| according to the | | | | | |
| invention—20 l/ha | | | | | |
| Recipe 16 not | 1.2 | 1.0 | 1.9 | 0 | 0 |
| according to the | | | | | |
| invention—200 l/ha | | | | | |
| Recipe 16 not | 1.2 | 0.7 | 2.1 | 0 | 0 |
| according to the | | | | | |
| invention—300 l/ha | | | | | |
| Recipe 17 | 230.0 | 177.0 | 93.4 | 20 | 0.2 |
| according to the | | | | | |
| invention—10 l/ha | | | | | |
| Recipe 17 | 127.8 | 101.0 | 83.5 | 20 | 0.1 |
| according to the | | | | | |
| invention—20 l/ha | | | | | |
| Recipe 17 | 11.9 | 12.3 | 10.9 | 20 | 0.01 |
| according to the | | | | | |
| invention—200 l/ha | | | | | |
| Recipe 17 | 5.9 | 7.7 | 8.3 | 20 | 0.007 |
| according to the | | | | | |
| invention—300 l/ha | | | | | |

Formulations applied at 0.5 1/ha.

The results show that the recipes illustrative of the invention show larger deposit sizes at 10 L/ha spray volume than at 200 L/ha, and than the recipe not according to the invention at all water volume uses.

6. Deltamethrin EC Formulation

TABLE 24
Deltamethrin EC Formulation

| | | Recipe 19 |
|---|---|---|
| | Recipe 18 | according to the |
| Component (g/L) | reference | invention |
| Deltamethrin | 48.0 | 48.0 |
| NANSA EVM 40/2NDL | 40.0 | 40.0 |
| Emulsogen EL 400 | 40.0 | 40.0 |
| Citric Acid | 1.0 | 1.0 |
| Silwet 806 | — | 120.0 |
| Cyclohexanone | 100.0 | 100.0 |
| Solvesso 200 ND | 771.0 | 651.0 |

The method of preparation used was according to the EC preparation method.

BOP

The leaf deposit size was determined according to coverage method.

TABLE 25
Spray dilution droplet size and dose on non-textured leaves.

| | | | | Organo- |
|---|---|---|---|---|
| | | | Organo- | silicone |
| | Deposit | Deposit | silicone | surfactant |
| | area | area | surfactant | dose |
| | mm\hat{ }2 | mm\hat{ }2 | dose | % w/v |
| Recipe | apple | corn | g/ha | (g/100 mL) |
| Recipe 18 not | 1.4 | 1.6 | 0 | 0 |
| according to the | | | | |
| invention—10 l/ha | | | | |
| Recipe 18 not | 1.6 | 0.6 | 0 | 0 |
| according to the | | | | |
| invention—20 l/ha | | | | |
| Recipe 18 not | 1.6 | 0.9 | 0 | 0 |
| according to the | | | | |
| invention—200 l/ha | | | | |
| Recipe 19 according to | 2.5 | 9.6 | 30 | 0.3 |
| the invention—10 l/ha | | | | |
| Recipe 19 according to | 4.4 | 11.6 | 30 | 0.15 |
| the invention—20 l/ha | | | | |
| Recipe 19 according to | 7.0 | 12.8 | 30 | 0.015 |
| the invention—200 l/ha | | | | |

Formulations applied at 0.25 1/ha.

The results show that on non-structured leaves the deposits size is similar or higher at higher water application volume.

TABLE 26
Spray dilution droplet size and dose on textured leaves.

| | | | | | Organo- |
|---|---|---|---|---|---|
| | | | | Organo- | silicone |
| | Deposit | Deposit | Deposit | silicone | surfactant |
| | area | area | area | surfactant | dose |
| | mm\hat{ }2 | mm\hat{ }2 | mm\hat{ }2 | dose | % w/v |
| Recipe | soybean | rice | barley | g/ha | (g/100 mL) |
| Recipe 18 not | 2.1 | 1.1 | 1.8 | 0 | 0 |
| according to the | | | | | |
| invention—10 l/ha | | | | | |
| Recipe 18 not | 1.0 | 0.9 | 0.8 | 0 | 0 |
| according to the | | | | | |
| invention—20 l/ha | | | | | |
| Recipe 18 not | 1.6 | 0.1 | 0.5 | 0 | 0 |
| according to the | | | | | |
| invention—200 l/ha | | | | | |
| Recipe 19 | 5.1 | 4.0 | 5.4 | 30 | 0.3 |
| according to the | | | | | |
| invention—10 l/ha | | | | | |
| Recipe 19 | 18.6 | 6.2 | 9.4 | 30 | 0.15 |
| according to the | | | | | |
| invention—20 l/ha | | | | | |
| Recipe 19 | 19.8 | 5.2 | 5.4 | 30 | 0.015 |
| according to the | | | | | |
| invention—200 l/ha | | | | | |

Formulations applied at 0.25 1/ha.

The results show that the recipes illustrative of the invention show larger deposit sizes on textured leaves at 20 L/ha spray volume than at 200 L/ha, and than the recipe not according to the invention at all water volume uses.

7. Clothianidin, Imidacloprid, Thiacloprid recipes

TABLE 27
Clothiandin, Imidacloprid, Thiacloprid SC recipes

| | Rec- | Recipe | Rec- | Recipe | Rec- | Recipe |
|---|---|---|---|---|---|---|
| | ipe | 21 | ipe | 23 | ipe | 25 |
| | 20 | according | 22 | according | 24 | according |
| Component | refer- | to the | refer- | to the | refer- | to the |
| (g/L) | ence | invention | ence | invention | ence | invention |
| Clothianidin | 100 | 100 | — | — | — | — |
| Imidacloprid | — | — | 50 | 50 | — | — |
| Thiacloprid | — | — | — | — | 120 | 120 |
| Atlox 4913 | 70 | 70 | 52 | 52 | 33 | 33 |
| Atlox 4894 | 12 | 12 | — | — | — | — |
| | | | — | — | — | — |
| Lucramul | — | — | 17 | 17 | 11 | 11 |
| PS 54 | | | | | | |
| Rhodopol 23 | 4 | 4 | 4 | 4 | 4 | 4 |
| Sipernat 22 | 6 | 6 | — | — | — | — |
| S | | | | | | |
| Silwet ® HS | — | 40 | — | 40 | — | 40 |
| 312 | | | | | | |
| | — | — | — | — | — | — |
| Proxel GXL | 1.2 | 1.2 | 1.2 | 1.2 | 1.2 | 1.2 |
| Kathon | 0.8 | 0.8 | 0.8 | 0.8 | 0.8 | 0.8 |
| CG/ICP | | | | | | |
| Glycerin | 116 | 116 | 115 | 115 | — | — |
| Urea | — | — | — | — | 111 | 111 |
| SAG1572 | 2 | 2 | 1 | 1 | 1 | 1 |
| Water (add | fill | fill | fill | fill | fill | fill |
| to 1 litre) | | | | | | |

BOP

The leaf deposit size was determined according to coverage method.

TABLE 28
Spray dilution droplet size and dose on non-textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | apple | g/ha | (g/100 mL) |
| Recipe 20 not | 9.2 | 0 | 0 |
| according to the | | | |
| invention—10 l/ha | | | |
| Recipe 20 not | 8.6 | 0 | 0 |
| according to the | | | |
| invention—20 l/ha | | | |
| Recipe 20 not | 6.4 | 0 | 0 |
| according to the | | | |
| invention—200 l/ha | | | |
| Recipe 21 according to | 13.7 | 40 | 0.4 |
| the invention—10 l/ha | | | |
| Recipe 21 according to | 13.6 | 40 | 0.2 |
| the invention—20 l/ha | | | |
| Recipe 21 according to | 12.8 | 40 | 0.02 |
| the invention—200 l/ha | | | |

Formulations applied at 11/ha.

The results show that on non-structured leaves the deposit size is similar or slightly higher at low water application volume.

TABLE 29
Spray dilution droplet size and dose on textured leaves.

| | | | | | Super- |
|---|---|---|---|---|---|
| | | | | Super- | spreading |
| | Deposit | Deposit | Deposit | spreading | surfactant |
| | area | area | area | surfactant | dose |
| | mm\hat{ }2 | mm\hat{ }2 | mm\hat{ }2 | dose | % w/v |
| Recipe | soybean | rice | barley | g/ha | (g/100 mL) |
| Recipe 20 not | 5.8 | 6.1 | 7.9 | 0 | 0 |
| according to the | | | | | |
| invention—10 l/ha | | | | | |
| Recipe 20 not | 5.0 | 6.9 | 7.5 | 0 | 0 |
| according to the | | | | | |
| invention—20 l/ha | | | | | |
| Recipe 20 not | 3.1 | 2.5 | 4.2 | 0 | 0 |
| according to the | | | | | |
| invention—200 l/ha | | | | | |
| Recipe 21 | 201.7 | 119.4 | 102.3 | 40 | 0.4 |
| according to the | | | | | |
| invention—10 l/ha | | | | | |
| Recipe 21 | 256.7 | 138.0 | 123.8 | 40 | 0.2 |
| according to the | | | | | |
| invention—20 l/ha | | | | | |
| Recipe 21 | 25.2 | 31.1 | 31.5 | 40 | 0.02 |
| according to the | | | | | |
| invention—200 l/ha | | | | | |

Formulations applied at 11/ha.

The results show that the recipes illustrative of the invention show larger deposit sizes at 10 L/ha spray volume than at 200 L/ha, and than the recipe not according to the invention at all water volume uses.

TABLE 30
Spray dilution droplet size and dose on non-textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | apple | g/ha | (g/100 mL) |
| Recipe 22 not | 4.7 | 0 | 0 |
| according to the | | | |
| invention—10 l/ha | | | |
| Recipe 22 not | 4.5 | 0 | 0 |
| according to the | | | |
| invention—20 l/ha | | | |
| Recipe 22 not | 1.7 | 0 | 0 |
| according to the | | | |
| invention—200 l/ha | | | |
| Recipe 23 according to | 11.9 | 40 | 0.4 |
| the invention—10 l/ha | | | |
| Recipe 23 according to | 12.8 | 40 | 0.2 |
| the invention—20 l/ha | | | |
| Recipe 23 according to | 10.3 | 40 | 0.02 |
| the invention—200 l/ha | | | |

Formulations applied at 11/ha.

The results show that on non-structured leaves the deposit size is higher or similar at low water application volume.

TABLE 31
Spray dilution droplet size and dose on textured leaves.

| | | | | | Super- |
|---|---|---|---|---|---|
| | | | | Super- | spreading |
| | Deposit | Deposit | Deposit | spreading | surfactant |
| | area | area | area | surfactant | dose |
| | mm\hat{ }2 | mm\hat{ }2 | mm\hat{ }2 | dose | % w/v |
| Recipe | soybean | rice | barley | g/ha | (g/100 mL) |
| Recipe 22 not | 2.5 | 1.5 | 3.8 | 0 | 0 |
| according to the | | | | | |
| invention—10 l/ha | | | | | |
| Recipe 22 not | 1.7 | 1.6 | 3.5 | 0 | 0 |
| according to the | | | | | |
| invention—20 l/ha | | | | | |
| Recipe 22 not | 1.1 | 1.0 | 2.2 | 0 | 0 |
| according to the | | | | | |
| invention—200 l/ha | | | | | |
| Recipe 23 | 179.0 | | 95.7 | 40 | 0.4 |
| according to the | | | | | |
| invention—10 l/ha | | | | | |
| Recipe 23 | 236.1 | | 94.6 | 40 | 0.2 |
| according to the | | | | | |
| invention—20 l/ha | | | | | |
| Recipe 23 | 10.8 | | 15.9 | 40 | 0.02 |
| according to the | | | | | |
| invention—200 l/ha | | | | | |

Formulations applied at 11/ha.

The results show that the recipes illustrative of the invention show larger deposit sizes at 20 L/ha spray volume than at 200 L/ha, and than the recipe not according to the invention at all water volume uses

TABLE 32
Spray dilution droplet size and dose on non-textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | apple | g/ha | (g/100 mL) |
| Recipe 24 not | 5.3 | 0 | 0 |
| according to the | | | |
| invention—10 l/ha | | | |
| Recipe 24 not | 5.0 | 0 | 0 |
| according to the | | | |
| invention—20 l/ha | | | |
| Recipe 24 not | 3.0 | 0 | 0 |
| according to the | | | |
| invention—200 l/ha | | | |
| Recipe 25 according to | 14.6 | 40 | 0.4 |
| the invention—10 l/ha | | | |
| Recipe 25 according to | 12.9 | 40 | 0.2 |
| the invention—20 l/ha | | | |
| Recipe 25 according to | 12.3 | 40 | 0.02 |
| the invention—200 l/ha | | | |

Formulations applied at 11/ha.

The results show that on non-structured leaves the deposit size is higher at higher water application volume.

TABLE 33
Spray dilution droplet size and dose on textured leaves.

| | | | | | Super- |
|---|---|---|---|---|---|
| | | | | | spreading |
| | | De- | De- | Super- | surfactant |
| | Deposit | posit | posit | spreading | dose |
| | area | area | area | surfactant | % w/v |
| | mm\hat{ }2 | mm\hat{ }2 | mm\hat{ }2 | dose | (g/100 |
| Recipe | soybean | rice | barley | g/ha | mL) |
| Recipe 24 not | 2.7 | 1.7 | 4.2 | 0 | 0 |
| according to the | | | | | |
| invention - 10 l/ha | | | | | |
| Recipe 24 not | 2.2 | 1.2 | 3.5 | 0 | 0 |
| according to the | | | | | |
| invention - 20 l/ha | | | | | |
| Recipe 24 not | 1.8 | 0.5 | 2.5 | 0 | 0 |
| according to the | | | | | |
| invention - 200 l/ha | | | | | |
| Recipe 25 according to | 255.4 | 121.8 | 98.8 | 40 | 0.4 |
| the invention - 10 l/ha | | | | | |
| Recipe 25 according to | 237.9 | 105.8 | 103.5 | 40 | 0.2 |
| the invention - 20 l/ha | | | | | |
| Recipe 25 according to | 16.8 | 22.3 | 27.7 | 40 | 0.02 |
| the invention - 200 l/ha | | | | | |

Formulations applied at 11/ha.

The results show that the recipes illustrative of the invention show larger deposit sizes at 10 L/ha spray volume than at 200 L/ha, and than the recipe not according to the invention at all water volume uses

8. Ethiprole, Fipronil recipes

TABLE 34
Ethiprole, Fipronil SC recipes

| | Rec- | Recipe | Rec- | Recipe | Rec- | Recipe |
|---|---|---|---|---|---|---|
| | ipe | 27 | ipe | 29 | ipe | 31 |
| | 26 | according | 28 | according | 30 | according |
| Component | refer- | to the | refer- | to the | refer- | to the |
| (g/L) | ence | invention | ence | invention | ence | invention |
| Ethiprole | 100 | 100 | — | — | 100 | 100 |
| Fipronil | — | — | 50 | 50 | — | — |
| Imidacloprid | — | — | — | — | 100 | 100 |
| Soprophor | 38 | 38 | 14 | 14 | — | — |
| FLK | | | | | | |
| Morwet | — | — | 14 | 14 | 11 | 11 |
| D425 | | | | | | |
| Rhodasruf | — | — | 5 | 5 | — | — |
| 860/P | | | | | | |
| Atlox 4913 | — | — | — | — | 69 | 69 |
| Atlas G | — | — | — | — | 22 | 22 |
| 5000 | | | | | | |
| Citric Acid | 0.2 | 0.2 | 0.2 | 0.2 | 2 | 2 |
| Rhodopol 23 | 4 | 4 | 4 | 4 | 4 | 4 |
| Van Gel B | 5 | 5 | — | — | — | — |
| Veegum R | — | — | — | — | 6 | 6 |
| Silwet ® HS | — | 40 | — | 40 | — | 40 |
| 312 | | | | | | |
| | — | — | — | — | — | — |
| Kathon | 0.8 | 0.8 | 0.8 | 0.8 | 0.8 | 0.8 |
| CG/ICP | | | | | | |
| Proxel GXL | 1.2 | 1.2 | 1.2 | 1.2 | 1.2 | 1.2 |
| Propylene | 123 | 123 | 51 | 51 | 110 | 110 |
| Glycol | | | | | | |
| SAG1572 | 3 | 3 | 3 | 3 | — | — |
| Silcolapse | — | — | — | — | 3 | 3 |
| 426R | | | | | | |
| Water (add | fill | fill | fill | fill | fill | fill |
| to 1 litre) | | | | | | |

BOP

The leaf deposit size was determined according to coverage method.

TABLE 35
Spray dilution droplet size and dose on non-textured leaves.

| | Deposit | | Organosilicone |
|---|---|---|---|
| | area | Organosilicone | surfactant dose |
| | mm\hat{ }2 | surfactant dose | % w/v |
| Recipe | apple | g/ha | (g/100 mL) |
| Recipe 26 not | 4.2 | 0 | 0 |
| according to the | | | |
| invention - 10 l/ha | | | |
| Recipe 26 not | 5.1 | 0 | 0 |
| according to the | | | |
| invention - 20 l/ha | | | |
| Recipe 26 not | 2.4 | 0 | 0 |
| according to the | | | |
| invention - 200 l/ha | | | |
| Recipe 26 not | 2.0 | 0 | 0 |
| according to the | | | |
| invention - 300 l/ha | | | |
| Recipe 27 according to | 14.7 | 20 | 0.2 |
| the invention - 10 l/ha | | | |
| Recipe 27 according to | 13.5 | 20 | 0.1 |
| the invention - 20 l/ha | | | |
| Recipe 27 according to | 11.8 | 20 | 0.01 |
| the invention - 200 l/ha | | | |
| Recipe 27 according to | 8.6 | 20 | 0.006 |
| the invention - 300 l/ha | | | |

Formulations applied at 0.5 1/ha.

The results show that on non-structured leaves the deposit size is slightly higher at higher water application volume.

TABLE 36
Spray dilution droplet size and dose on textured leaves.

| | | | | | Organos- |
|---|---|---|---|---|---|
| | | | | | ilicone |
| | | De- | De- | Organo- | surfactant |
| | Deposit | posit | posit | silicone | dose |
| | area | area | area | surfactant | % w/v |
| | mm\hat{ }2 | mm\hat{ }2 | mm\hat{ }2 | dose | (g/100 |
| Recipe | soybean | rice | barley | g/ha | mL) |
| Recipe 26 not | 2.9 | 2.0 | 3.9 | 0 | 0 |
| according to the | | | | | |
| invention - 10 l/ha | | | | | |
| Recipe 26 not | 2.6 | 1.9 | 4.6 | 0 | 0 |
| according to the | | | | | |
| invention - 20 l/ha | | | | | |
| Recipe 26 not | 1.9 | 1.0 | 2.7 | 0 | 0 |
| according to the | | | | | |
| invention - 200 l/ha | | | | | |
| Recipe 26 not | 1.8 | 0.9 | 2.3 | 0 | 0 |
| according to the | | | | | |
| invention - 300 l/ha | | | | | |
| Recipe 27 according to | 209.0 | 136.0 | 104.0 | 20 | 0.2 |
| the invention - 10 l/ha | | | | | |
| Recipe 27 according to | 144.8 | 88.4 | 85.2 | 20 | 0.1 |
| the invention - 20 l/ha | | | | | |
| Recipe 27 according to | 10.5 | 13.6 | 15.6 | 20 | 0.01 |
| the invention - 200 l/ha | | | | | |
| Recipe 27 according to | 7.4 | 9.6 | 8.7 | 20 | 0.006 |
| the invention - 300 l/ha | | | | | |

Formulations applied at 0.5 1/ha.

The results show that the recipes illustrative of the invention show larger deposit sizes at 10 L/ha spray volume than at 200 L/ha, and than the recipe not according to the invention at all water volume uses.

TABLE 37
Spray dilution droplet size and dose on non-textured leaves.

| | | | Organosilicone |
|---|---|---|---|
| | Deposit | Organosilicone | surfactant dose |
| | area mm\hat{ }2 | surfactant dose | % w/v |
| Recipe | apple | g/ha | (g/100 mL) |
| Recipe 28 not | 7.4 | 0 | 0 |
| according to the | | | |
| invention - 10 l/ha | | | |
| Recipe 28 not | 6.4 | 0 | 0 |
| according to the | | | |
| invention - 20 l/ha | | | |
| Recipe 28 not | 4.8 | 0 | 0 |
| according to the | | | |
| invention - 200 l/ha | | | |
| Recipe 28 not | 1.1 | 0 | 0 |
| according to the | | | |
| invention - 300 l/ha | | | |
| Recipe 29 according to | 12.1 | 20 | 0.2 |
| the invention - 10 l/ha | | | |
| Recipe 29 according to | 12.0 | 20 | 0.1 |
| the invention - 20 l/ha | | | |
| Recipe 29 according to | 9.7 | 20 | 0.01 |
| the invention - 200 l/ha | | | |
| Recipe 29 according to | 9.0 | 20 | 0.006 |
| the invention - 300 l/ha | | | |

Formulations applied at 11/ha.

The results show that on non-structured leaves the deposit size is slightly higher at low water application volumes.

TABLE 38
Spray dilution droplet size and dose on textured leaves.

| | | | | | Organo- |
|---|---|---|---|---|---|
| | | | | | silicone |
| | | De- | De- | Organo- | surfactant |
| | Deposit | posit | posit | silicone | dose |
| | area | area | area | surfactant | % w/v |
| | mm\hat{ }2 | mm\hat{ }2 | mm\hat{ }2 | dose | (g/100 |
| Recipe | soybean | rice | barley | g/ha | mL) |
| Recipe 28 not | 4.5 | 3.8 | 4.8 | 0 | 0 |
| according to the | | | | | |
| invention - 10 l/ha | | | | | |
| Recipe 28 not | 3.7 | 2.8 | 4.3 | 0 | 0 |
| according to the | | | | | |
| invention - 20 l/ha | | | | | |
| Recipe 28 not | 2.1 | 2.0 | 3.4 | 0 | 0 |
| according to the | | | | | |
| invention - 200 l/ha | | | | | |
| Recipe 28 not | 1.7 | 1.3 | 2.2 | 0 | 0 |
| according to the | | | | | |
| invention - 300 l/ha | | | | | |
| Recipe 29 according to | 171.0 | 165.0 | 94.2 | 20 | 0.2 |
| the invention - 10 l/ha | | | | | |
| Recipe 29 according to | 169.4 | 113.0 | 89.1 | 20 | 0.1 |
| the invention - 20 l/ha | | | | | |
| Recipe 29 according to | 11.4 | 18.4 | 14.5 | 20 | 0.01 |
| the invention - 200 l/ha | | | | | |
| Recipe 29 according to | 7.8 | 14.7 | 12.3 | 20 | 0.006 |
| the invention - 300 l/ha | | | | | |

Formulations applied at 11/ha.

The results show that the recipes illustrative of the invention show larger deposit sizes at 10 L/ha spray volume than at 200 L/ha, and than the recipe not according to the invention at all water volume uses.

TABLE 39
Spray dilution droplet size and dose on non-textured leaves.

| | Deposit | | Organosilicone |
|---|---|---|---|
| | area | Organosilicone | surfactant dose |
| | mm\hat{ }2 | surfactant dose | % w/v |
| Recipe | apple | g/ha | (g/100 mL) |
| Recipe 30 not | 5.5 | 0 | 0 |
| according to the | | | |
| invention - 10 l/ha | | | |
| Recipe 30 not | 5.5 | 0 | 0 |
| according to the | | | |
| invention - 20 l/ha | | | |
| Recipe 30 not | 1.0 | 0 | 0 |
| according to the | | | |
| invention - 200 l/ha | | | |
| Recipe 30 not | 1.0 | 0 | 0 |
| according to the | | | |
| invention - 300 l/ha | | | |
| Recipe 31 according to | 13.0 | 20 | 0.2 |
| the invention - 10 l/ha | | | |
| Recipe 31 according to | 12.0 | 20 | 0.1 |
| the invention - 20 l/ha | | | |
| Recipe 31 according to | 8.9 | 20 | 0.01 |
| the invention - 200 l/ha | | | |
| Recipe 31 according to | 7.9 | 20 | 0.006 |
| the invention - 300 l/ha | | | |

Formulations applied at 0.5 1/ha.

The results show that on non-structured leaves the deposit size is slightly higher at low water application volumes.

TABLE 40
Spray dilution droplet size and dose on textured leaves.

| | | | | | Organo- |
|---|---|---|---|---|---|
| | | | | | silicone |
| | | De- | De- | Organo- | surfactant |
| | Deposit | posit | posit | silicone | dose |
| | area | area | area | surfactant | % w/v |
| | mm\hat{ }2 | mm\hat{ }2 | mm\hat{ }2 | dose | (g/100 |
| Recipe | soybean | rice | barley | g/ha | mL) |
| Recipe 30 not | 2.4 | 1.5 | 4.1 | 0 | 0 |
| according to the | | | | | |
| invention - 10 l/ha | | | | | |
| Recipe 30 not | 2.1 | 1.5 | 3.4 | 0 | 0 |
| according to the | | | | | |
| invention - 20 l/ha | | | | | |
| Recipe 30 not | 1.8 | 0.9 | 2.3 | 0 | 0 |
| according to the | | | | | |
| invention - 200 l/ha | | | | | |
| Recipe 30 not | 1.1 | 0.9 | 2.3 | 0 | 0 |
| according to the | | | | | |
| invention - 300 l/ha | | | | | |
| Recipe 31 according to | 150.0 | 141.0 | 93.9 | 20 | 0.2 |
| the invention - 10 l/ha | | | | | |
| Recipe 31 according to | 86.0 | 73.6 | 53.9 | 20 | 0.1 |
| the invention - 20 l/ha | | | | | |
| Recipe 31 according to | 6.8 | 10.1 | 9.4 | 20 | 0.01 |
| the invention - 200 l/ha | | | | | |
| Recipe 31 according to | 5.3 | 5.5 | 7.4 | 20 | 0.006 |
| the invention - 300 l/ha | | | | | |

Formulations applied at 0.5 1/ha.

The results show that the recipes illustrative of the invention show larger deposit sizes at 10 L/ha spray volume than at 200 L/ha, and than the recipe not according to the invention at all water volume uses.

9. Fluopyram recipes

TABLE 41
Fluopyram SC recipes

| | | Recipe 33 |
|---|---|---|
| | Recipe | according |
| Component | 32 | to the |
| (g/L) | reference | invention |
| Fluopyram | 100 | 100 |
| Surfynol | 4 | 4 |
| 440 | | |
| Morwet | 4 | 4 |
| D425 | | |
| Synperonic | 44 | 44 |
| PE/F127 | | |
| Atlox 4913 | 3 | 3 |
| Citric Acid | 0.4 | 0.4 |
| Rhodopol | 4 | 4 |
| 23 | | |
| Silwet ® HS | — | 40 |
| 312 | | |
| | — | — |
| Kathon | 0.8 | 0.8 |
| CG/ICP | | |
| Proxel GXL | 1.2 | 1.2 |
| Propylene | 81 | 81 |
| Glycol | | |
| SAG1572 | 3 | 3 |
| Silcolapse | — | — |
| 426R | | |
| Water (add | fill | fill |
| to 1 litre) | | |

BOP

The leaf deposit size was determined according to coverage method.

TABLE 42
Spray dilution droplet size and dose on non-textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | apple | g/ha | (g/100 mL) |
| Recipe 32 not | 6.4 | 0 | 0 |
| according to the | | | |
| invention - 10 l/ha | | | |
| Recipe 32 not | 5.5 | 0 | 0 |
| according to the | | | |
| invention - 20 l/ha | | | |
| Recipe 32 not | 3.6 | 0 | 0 |
| according to the | | | |
| invention - 200 l/ha | | | |
| Recipe 33 not | 14.0 | 40 | 0.4 |
| according to the | | | |
| invention - 10 l/ha | | | |
| Recipe 33 not | 11.6 | 40 | 0.2 |
| according to the | | | |
| invention - 20 l/ha | | | |
| Recipe 33 according to | 8.6 | 40 | 0.02 |
| the invention - 200 l/ha | | | |

Formulations applied at 11/ha.

The results show that on non-structured leaves the deposit size is slightly higher at low water application volumes.

TABLE 43
Spray dilution droplet size and dose on textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | soybean | g/ha | (g/100 mL) |
| Recipe 32 not | 2.9 | 0 | 0 |
| according to the | | | |
| invention - 10 l/ha | | | |
| Recipe 32 not | 2.4 | 0 | 0 |
| according to the | | | |
| invention - 20 l/ha | | | |
| Recipe 32 not | 1.7 | 0 | 0 |
| according to the | | | |
| invention - 200 l/ha | | | |
| Recipe 33 according to | 135.7 | 40 | 0.4 |
| the invention - 10 l/ha | | | |
| Recipe 33 according to | 86.1 | 40 | 0.2 |
| the invention - 20 l/ha | | | |
| Recipe 33 according to | 9.5 | 40 | 0.02 |
| the invention - 200 l/ha | | | |

Formulations applied at 11/ha.

The results show that the recipes illustrative of the invention show larger deposit sizes at 10 L/ha spray volume than at 200 L/ha, and than the recipe not according to the invention at all water volume uses.

10. Flupyradifurone recipes

TABLE 44
Flupyradifurone recipes

| | | Recipe 35 |
|---|---|---|
| | Recipe | according |
| Component | 34 | to the |
| (g/L) | reference | invention |
| Flupyradifurone | 200 | 200 |
| Mowiol 8-88 | 33 | 33 |
| Atlox 4894 | 11 | 11 |
| Atlox 4913 | 50 | 50 |
| Citric Acid | 0.5 | 0.5 |
| Rhodopol 23 | 2 | 2 |
| Aerosil R972 | 7 | 7 |
| Silwet ® HS 312 | — | 40 |
| | — | — |
| Kathon CG/ICP | 0.8 | 0.8 |
| Proxel GXL | 1.2 | 1.2 |
| Urea | 71 | 71 |
| SAG1572 | 11 | 11 |
| Silcolapse 426R | — | — |
| Water (add to 1 | fill | fill |
| litre) | | |

BOP

The leaf deposit size was determined according to coverage method.

TABLE 45
Spray dilution droplet size and dose on non-textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | apple | g/ha | (g/100 mL) |
| Recipe 34 not | 6.5 | 0 | 0 |
| according to the | | | |
| invention - 10 l/ha | | | |
| Recipe 34 not | 3.5 | 0 | 0 |
| according to the | | | |
| invention - 200 l/ha | | | |
| Recipe 35 not | 9.9 | 40 | 0.4 |
| according to the | | | |
| invention - 10 l/ha | | | |
| Recipe 35 according to | 8.3 | 40 | 0.02 |
| the invention - 200 l/ha | | | |

Formulations applied at 11/ha.

The results show that on non-structured leaves the deposit size is slightly higher at low water application volume.

TABLE 46
Spray dilution droplet size and dose on textured leaves.

| | | | Super- |
|---|---|---|---|
| | | Super- | spreading |
| | Deposit | spreading | surfactant |
| | area | surfactant | dose |
| | mm\hat{ }2 | dose | % w/v |
| Recipe | soybean | g/ha | (g/100 mL) |
| Recipe 34 not | 3.7 | 0 | 0 |
| according to the | | | |
| invention - 10 l/ha | | | |
| Recipe 34 not | 1.5 | 0 | 0 |
| according to the | | | |
| invention - 200 l/ha | | | |
| Recipe 35 not | 308.3 | 40 | 0.4 |
| according to the | | | |
| invention - 10 l/ha | | | |
| Recipe 35 according to | 8.3 | 40 | 0.02 |
| the invention - 200 l/ha | | | |

Formulations applied at 11/ha.

The results show that the recipes illustrative of the invention show larger deposit sizes at 10 L/ha spray volume than at 200 L/ha, and than the recipe not according to the invention at all water volume uses.

11. Greenhouse Biology data

TETRANILIPROLE SC040 formulations

Test methodology: application onto upperside of pre-infested 1-leaf cabbage plants, BBCH12, for translaminar activity, 2 replicates.

TABLE 47
Biological efficacy (in % mortality) against mixed
population of Myzus persicae on pre-infested cabbage,
evaluation 7 days after application

| | | Recipe 7 not | Recipe 8 |
|---|---|---|---|
| Spray | Rate | according to | according to |
| volume | of a.i. | the | the |
| l/ha | g/ha | invention | invention |
| 300 | 100 | 0 | 0 |
| 300 | 20 | 0 | 0 |
| 300 | 4 | 0 | 0 |
| 10 | 100 | 85 | 93 |
| 10 | 20 | 0 | 35 |
| 10 | 4 | 0 | 0 |

The results show that the recipes according to the invention are more efficacious than the reference recipes, and the biological efficacy of the recipes according to the invention is also better at 10 1/ha than at 300 1/ha

Imidacloprid+Ethiprole SC200 formulation

Test methodology: application onto upperside of soybeans, BBCH12, for contact and oral uptake, 2 replicates; artificial infestation with 10 Southern green stink bugs nymphs.

TABLE 48
Biological efficacy (in % mortality) against mixed population
of Nezara viridula (N2 nymphs) on soybean, evaluation 3 days
after application

| | Rate of a.i. g/ha | | | Rate of a.i. g/ha |
|---|---|---|---|---|
| | (delivered as | | | (delivered as |
| Spray | recipe 30 not | Rate of | | recipe not |
| volume | according to the | adjuvant | | according to the |
| l/ha | invention) | g/ha | % Mortality | invention 30) |
| 300 | 20 | 0 | 70 | 20 |
| 300 | 4 | 0 | 20 | 4 |
| 300 | 0.8 | 0 | 5 | 0.8 |
| 10 | 20 | 0 | 80 | 20 |
| 10 | 4 | 0 | 15 | 4 |
| 10 | 0.8 | 0 | 5 | 0.8 |
| | | Rate of | | % Mortality |
| | | adjuvant | Concentration | (tank |
| | Spray | Silwet | of adjuvant | mix adjuvanted |
| | volume | HS312 | in spray | SC200 |
| | l/ha | g/ha | solution (g/l) | formulation) |
| | 300 | 30 | 0.1 | 75 |
| | 300 | 30 | 0.1 | 30 |
| | 300 | 30 | 0.1 | 0 |
| | 10 | 30 | 3 | 100 |
| | 10 | 30 | 3 | 80 |
| | 10 | 30 | 3 | 40 |

The results show that the addition of Silwet HS312 improves the biological efficacy of the active ingredients, particularly at 10 1/ha water spray volume

1. An agrochemical formulation comprising
a) one or more active ingredients selected from the group of agrochemically applied insecticides,
b) an organosilicone based surfactant,
c) one or more other formulants, and
d) carrier to volume,
wherein b) is present in an amount from 0.5 to 15% by weight.

2. The agrochemical formulation according to claim 1, wherein b) is a polyalkyleneoxide modified heptamethyltrisiloxane.

3. The agrochemical formulation according to claim 1, wherein a) is present in an amount from 0.5 to 30% by weight, preferably from 1 to 27.5% by weight, and most preferably from 1.2 to 25% by weight.

4. The agrochemical formulation according to claim 1, wherein the insecticide is selected from the group consisting of spirotetramat, spiromesifen, spidoxamate (IUPAC Name: 1i-(4-chloro-2,6-xylyl)-12-hydroxy-1,4-dioxa-9-azadispiro[4.2.4.2]tetradec-11-en-10-one), flubendiamide, tetraniliprole, deltamethrin, ß-cyfluthrin, imidacloprid, thiacloprid, ethiprole, fipronil, fluopyram and flupyradifurone.

5. The agrochemical formulation according to claim 1, wherein b) is present in an amount from 0.75 to 10% by weight, and more preferably from 1 to 6% by weight.

6. The agrochemical formulation according to claim 1, wherein c) is present in an amount from in 0.5 to 65% by weight, preferably from 1 to 49.5% by weight, and more preferably from 2 to 37.5% by weight.

7. The agrochemical formulation according to claim 1, wherein component c) comprises at least one non-ionic surfactant and/or ionic surfactant.

8. The agrochemical formulation according to claim 1, wherein component c) comprises at least one non-ionic surfactant (c1) and/or ionic surfactant, one rheological modifier (c2), one antifoam substance (c3), and one further formulant (c4).

9. The agrochemical formulation according to claim 8, wherein
c1) is present in an amount from 2 to 15% by weight,
c2) is present in an amount from 0.1 to 20% by weight,
c3) is present in an amount from 0.05 to 5% by weight, and
c4 is present in an amount from 0.1 to 20% by weight.

10. The agrochemical formulation according to claim 1, wherein the formulation is applied at a spray volume of between 1 and 20 1/ha, preferably between 2 and 15 1/ha, and more preferably between 5 and 15 1/ha.

11. A method of applying the agrochemical formulation according to claim 1 onto crops, wherein the formulation is applied at a spray volume of between 1 and 20 1/ha, preferably between 2 and 15 1/ha, and more preferably between 5 and 15 1/ha.

12. The method according to claim 11, wherein the applied amount of a) to the crop is between 2 and 250 g/ha, preferably between 5 and 225 g/ha, and more preferably between 10 and 200 g/ha.

13. The method according to claim 11, wherein the organosilicone-surfactant of b) is preferably applied from 5 g/ha to 150 g/ha, more preferably applied from 7.5 g/ha to 100 g/ha, and most preferably applied from 10 g/ha to 60 g/ha.

14. The method according to claim 11, wherein the formulation is applied on plants or crops with textured leaf surfaces.

15. A method of controlling harmful insecticidal pests, comprising applying the agrochemical formulation according to claim 1, wherein the formulation is applied by an unmanned aerial vehicle (UAV), an unmanned guided vehicle (UGV), or a pulse-width-module (PWM).

16. A method of controlling harmful organisms, comprising contacting the harmful organisms, habitats of the harmful organisms, or hosts of the harmful organisms, such as plants and seed, soil, areas and environments in which the harmful organisms grow or could grow, but also comprising contacting materials, plants, seeds, soil, surfaces or spaces which are to be protected from attack or infestation by organisms that are harmful to plants, with an effective amount of the formulation according to claim 1, characterized in that the formulation is applied by an unmanned aerial vehicle (UAV), an unmanned guided vehicle (UGV), or a pulse-width-module (PWM).
